(19) United States
(12) Patent Application Publication
(10) Pub. No.: US 2013/0222621 A1
(43) Pub. Date: Aug. 29, 2013

(54) INFORMATION PROCESSING APPARATUS, TERMINAL APPARATUS, IMAGE CAPTURING APPARATUS, INFORMATION PROCESSING METHOD, AND INFORMATION PROVISION METHOD FOR AN IMAGE CAPTURING APPARATUS

(71) Applicant: Sony Corporation, (US)

(72) Inventor: Nodoka Tokunaga, Tokyo (JP)

(73) Assignee: Sony Corporation, Tokyo (JP)

(21) Appl. No.: 13/767,327

(22) Filed: Feb. 14, 2013

(30) Foreign Application Priority Data
Feb. 23, 2012 (JP) 2012-037352

(51) Int. Cl. H04N 5/232

(52) U.S. Cl. CPC H04N 5/23254
USPC 348/208.1

(57) ABSTRACT

There is provided an information processing apparatus including a motion detection part detecting motion information of an object included in a moving image frame, and a cutout region decision part deciding a region to be cutout from the moving image frame using the motion information detected for each object by the motion detection part.

### BACKGROUND

The present technology relates to an information processing apparatus, a terminal apparatus, an image capturing apparatus, an information processing method, and an information provision method for an image capturing apparatus.

An environment is being ready in which video images captured by a digital camera or the like can be edited even in ordinary homes or the like. However, it is unexpectedly difficult for many users to capture images in composition preferred for the subject and/or to prepare images for insert shots. Regarding a technique of deciding such composition and a technique of inserting such insertion shot images, the following technical matters are disclosed, for example, in Japanese Patent Laid-Open No. H06-253197 and Japanese Patent Laid-Open No. 2006-302459 (hereinafter referred to as Patent Literatures 1 and 2, respectively).

Japanese Patent Laid-Open No. H06-253197 discloses a technique of detecting chronological change and the like from an image obtained by projecting a certain video image on time and space, and cutting out a part of the video image from the video image based on the detection result. Moreover, Japanese Patent Laid-Open No. 2006-302459 discloses a technique of acquiring an image in which an insert flag is beforehand configured, and inserting the acquired image as an inserting image between images determined not to be continuous in a certain video image regarding their continuity.

### SUMMARY

However, Japanese Patent Laid-Open No. H06-253197 does not mention at all a method of cutting out a video image in preferred composition in which motions of individual objects are considered with respect to the objects such as the subjects included in each frame of the video image. Moreover, Japanese Patent Laid-Open No. 2006-302459 does not mention at all a technique of automatically generate an image suitable for an insert shot image.

Therefore, the present technology is devised in view of these circumstances, and it is desirable to provide an information processing apparatus, a terminal apparatus, an image capturing apparatus, an information processing method, and an information provision method for an image capturing apparatus which are novel, improved and capable of realizing cutting-out of a moving image frame more naturally.

According to an embodiment of the present technology, there is provided an information processing apparatus including a motion detection part detecting motion information of an object included in a moving image frame, and a cutout region decision part deciding a region to be cutout from the moving image frame using the motion information detected for each object by the motion detection part.

Further, according to another embodiment of the present technology, there is provided a terminal apparatus including an image acquisition part acquiring a cutout image obtained via processes of detecting motion information of an object included in a moving image frame, deciding a region to be cutout from the moving image frame using the motion information detected for each object, and cutting out the decided region from the moving image frame.

Further, according to another embodiment of the present technology, there is provided an image capturing apparatus including a moving image provision part providing a captured moving image to a predetermined appliance, an auxiliary information acquisition part acquiring auxiliary information from the predetermined appliance that has performed processes of detecting motion information of an object included in a moving image frame of the captured moving image, deciding a region to be cutout from the moving image frame using the motion information detected for each object, and generating the auxiliary information regarding an image capturing method for capturing an image of the decided region, and an information provision part providing the auxiliary information to a user.

Further, according to another embodiment of the present technology, there is provided an information processing method including detecting motion information of an object included in a moving image frame, and deciding a region to be cutout from the moving image frame using the motion information detected for each object.

Further, according to another embodiment of the present technology, there is provided an information provision method for an image capturing apparatus, including providing a captured moving image to a predetermined appliance, acquiring auxiliary information from the predetermined appliance that has performed processes of detecting motion information of an object included in a moving image frame of the captured moving image, deciding a region to be cutout from the moving image frame using the motion information detected for each object, and generating the auxiliary information regarding an image capturing method for capturing an image of the decided region, and providing the auxiliary information to a user.

As described above, according to the embodiment of the present technology, more natural cutting-out of a moving image frame can be realized.

### BRIEF DESCRIPTION OF THE DRAWINGS

FIG. 1 is an explanatory drawing for explaining a motion detection technique of a plurality of objects;

FIG. 2 is an explanatory drawing for explaining the motion detection technique of a plurality of objects;

FIG. 3 is an explanatory drawing for explaining an overview of a composition determination technique according to an embodiment;

FIG. 4 is an explanatory drawing for explaining an overview of an insert shot image insertion technique according to the embodiment;

FIG. 5 is an explanatory drawing for explaining an example system configuration capable of realizing the composition determination technique and the insert shot image insertion technique according to the embodiment;

FIG. 6 is an explanatory drawing for explaining a functional configuration of an information processing apparatus capable of realizing the composition determination technique according to the embodiment;

FIG. 7 is an explanatory drawing for explaining the functional configuration of the information processing apparatus capable of realizing the composition determination technique according to the embodiment more in detail;

FIG. 8 is an explanatory drawing for explaining the functional configuration of the information processing apparatus capable of realizing the composition determination technique according to the embodiment more in detail;

FIG. 9 is an explanatory drawing for explaining the functional configuration of the information processing apparatus capable of realizing the composition determination technique according to the embodiment more in detail;

FIG. 10 is an explanatory drawing for specifically explaining an adjustment method of a subject region according to the embodiment;

FIG. 11 is an explanatory drawing for specifically explaining the adjustment method of a subject region according to the embodiment;

FIG. 12 is an explanatory drawing for specifically explaining an example of a cutout pattern according to the embodiment;

FIG. 13 is an explanatory drawing for specifically explaining examples of the cutout pattern according to the embodiment;

FIG. 14 is an explanatory drawing for specifically explaining an example of the cutout pattern according to the embodiment;

FIG. 15 is an explanatory drawing for specifically explaining a decision method of a cutout region according to the embodiment;

FIG. 16 is an explanatory drawing for specifically explaining a determination method of enclosure composition according to the embodiment;

FIG. 17 is an explanatory drawing for specifically explaining a cutout method according to the embodiment;

FIG. 18 is an explanatory drawing for specifically explaining a cutout method according to the embodiment;

FIG. 19 is an explanatory drawing for specifically explaining a cutout method according to the embodiment;

FIG. 20 is an explanatory drawing for explaining an overall flow of composition determination processing according to the embodiment;

FIG. 21 is an explanatory drawing for explaining a detection method of the subject region according to the embodiment;

FIG. 22 is an explanatory drawing for explaining a motion detection method according to the embodiment;

FIG. 23 is an explanatory drawing for explaining decision method of a cutout region according to the embodiment;

FIG. 24 is an explanatory drawing for explaining a functional configuration of an image capturing apparatus constituting a system capable of realizing an composition advice provision method to which the composition determination technique according to the embodiment is applied;

FIG. 25 is an explanatory drawing for explaining operation of an image capturing apparatus capable of realizing the composition advice provision method to which the composition determination technique according to the embodiment is applied;

FIG. 26 is an explanatory drawing for explaining operation of the image capturing apparatus capable of realizing the composition advice provision method to which the composition determination technique according to the embodiment is applied;

FIG. 27 is an explanatory drawing for explaining a functional configuration of an information processing system capable of realizing the composition advice provision method to which the composition determination technique according to the embodiment is applied;

FIG. 28 is an explanatory drawing for explaining operation of the information processing system capable of realizing the composition advice provision method to which the composition determination technique according to the embodiment is applied;

FIG. 29 is an explanatory drawing for explaining a functional configuration of an information processing apparatus capable of realizing the insert shot image insertion technique according to the embodiment;

FIG. 30 is an explanatory drawing for explaining the functional configuration of the information processing apparatus capable of realizing the insert shot image insertion technique according to the embodiment more in detail;

FIG. 31 is an explanatory drawing for explaining the functional configuration of the information processing apparatus capable of realizing the insert shot image insertion technique according to the embodiment more in detail;

FIG. 32 is an explanatory drawing for explaining the functional configuration of the information processing apparatus capable of realizing the insert shot image insertion technique according to the embodiment more in detail;

FIG. 33 is an explanatory drawing for explaining the functional configuration of the information processing apparatus capable of realizing the insert shot image insertion technique according to the embodiment more in detail;

FIG. 34 is an explanatory drawing for explaining the functional configuration of the information processing apparatus capable of realizing the insert shot image insertion technique according to the embodiment more in detail;

FIG. 35 is an explanatory drawing for explaining operation of the information processing apparatus capable of realizing the insert shot image insertion technique according to the embodiment;

FIG. 36 is an explanatory drawing for explaining the operation of the information processing apparatus capable of realizing the insert shot image insertion technique according to the embodiment;

FIG. 37 is an explanatory drawing for explaining the operation of the information processing apparatus capable of realizing the insert shot image insertion technique according to the embodiment;

FIG. 38 is an explanatory drawing for explaining the operation of the information processing apparatus capable of realizing the insert shot image insertion technique according to the embodiment;

FIG. 39 is an explanatory drawing for explaining the operation of the information processing apparatus capable of realizing the insert shot image insertion technique according to the embodiment;

FIG. 40 is an explanatory drawing for explaining the operation of the information processing apparatus capable of realizing the insert shot image insertion technique according to the embodiment; and

FIG. 41 is an explanatory drawing illustrating an example hardware configuration of an apparatus and system capable of realizing the composition determination technique and the insert shot image insertion technique according to the embodiment.

### DETAILED DESCRIPTION OF THE EMBODIMENTS

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

[Flow of Description]

Herein, a flow of the following description is mentioned simply.

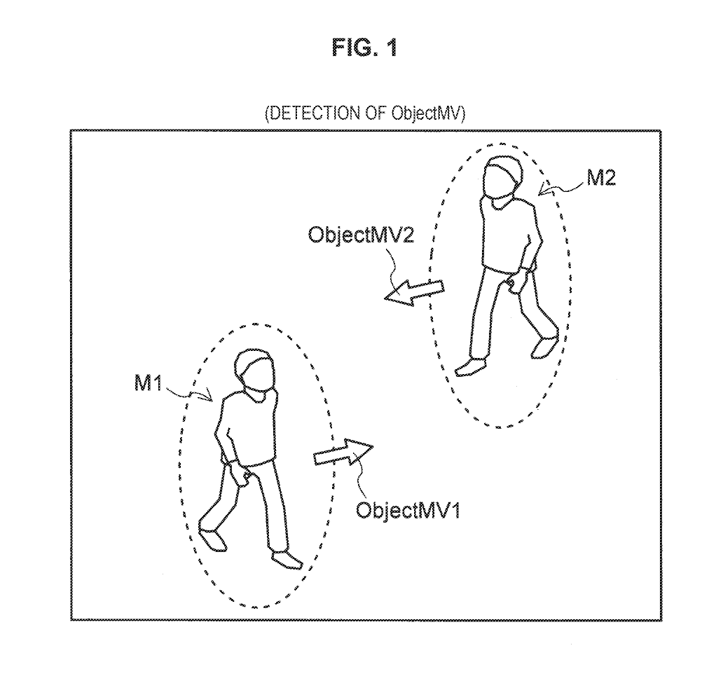

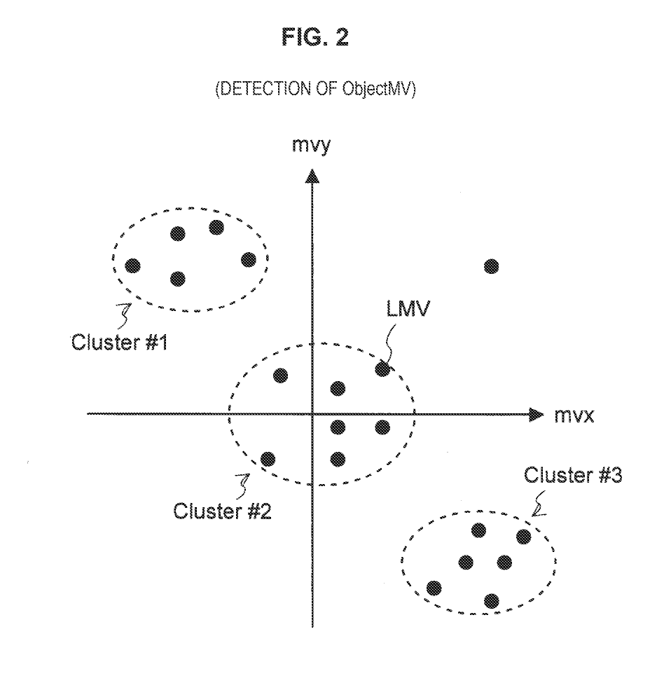

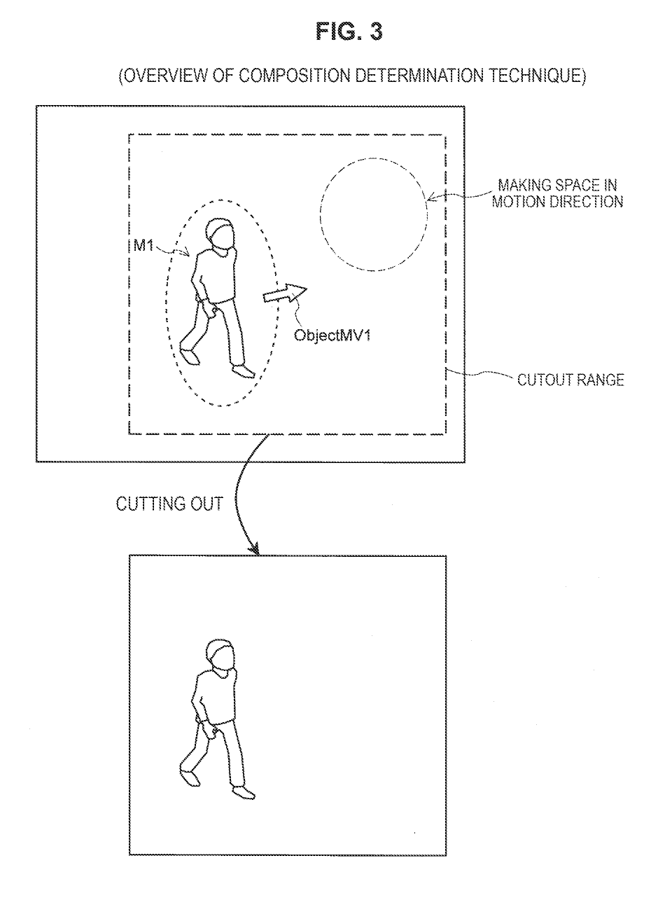

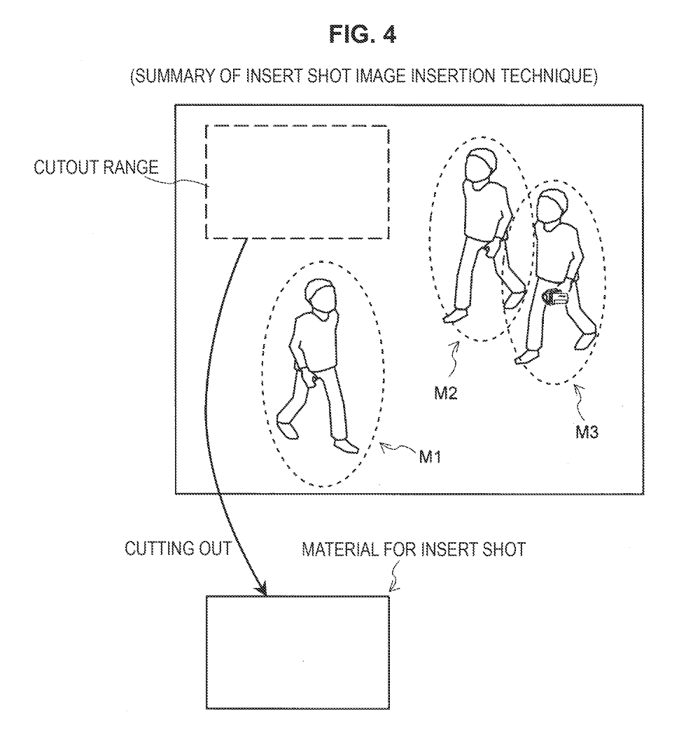

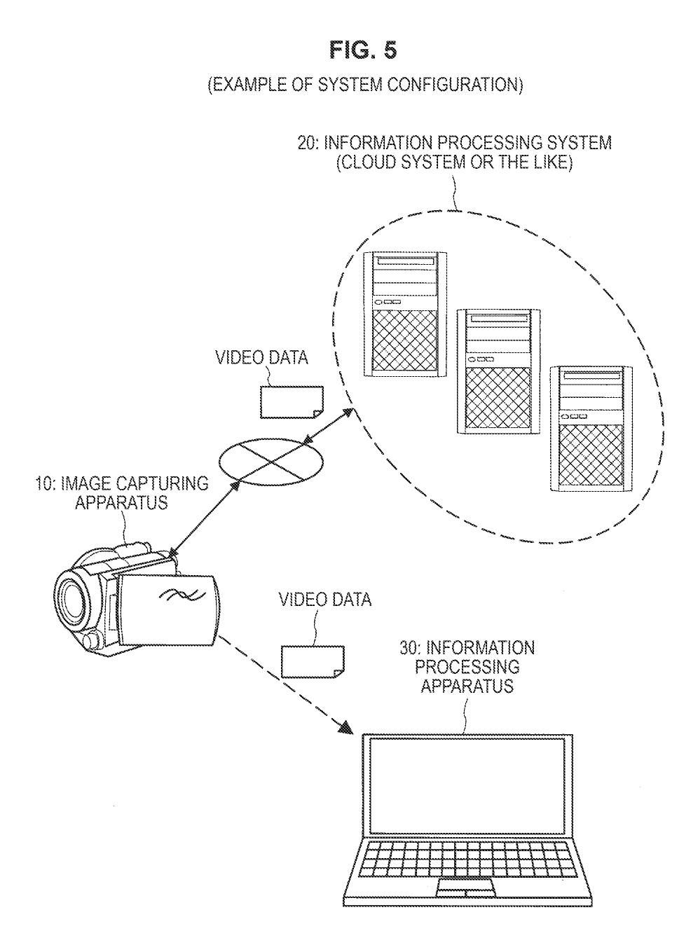

At first, a motion detection technique of a plurality of objects is described simply with reference to FIG. 1 and FIG. 2. Next, an overview of a composition determination technique according to the embodiment is described with reference to FIG. 3. Next, an overview of an insert shot image insertion technique according to the embodiment is described with reference to FIG. 4. Next, an example system configuration to which the composition determination technique and insert shot image insertion technique according to the embodiment can be applied is described with reference to FIG. 5

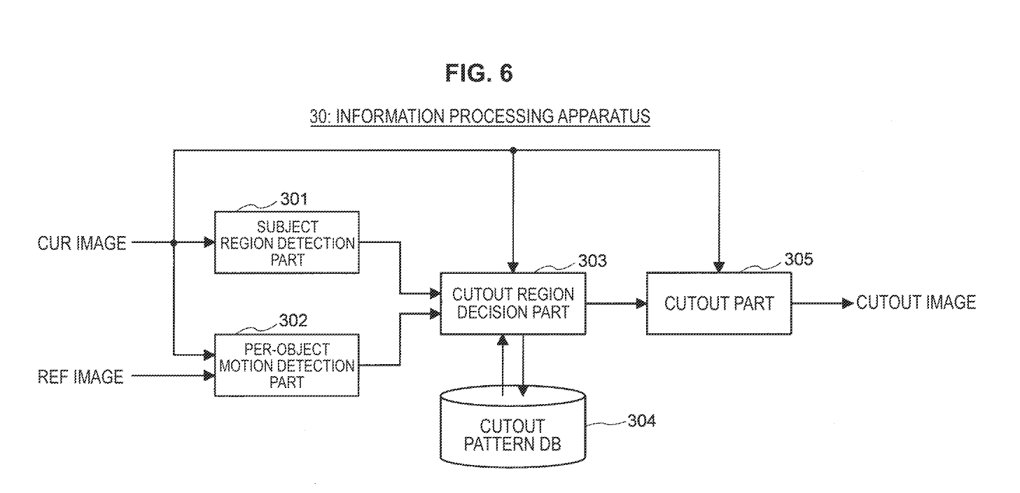

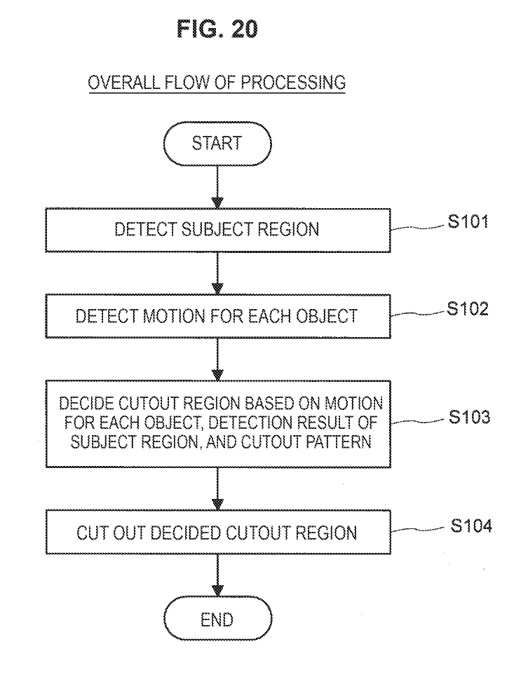

Next, a configuration of an information processing apparatus 30 capable of realizing the composition determination technique according to the embodiment is described with reference to FIG. 6 to FIG. 19. Next, operation of the information processing apparatus 30 capable of realizing the composition determination technique according to the embodiment is described with reference to FIG. 20 to FIG. 23.

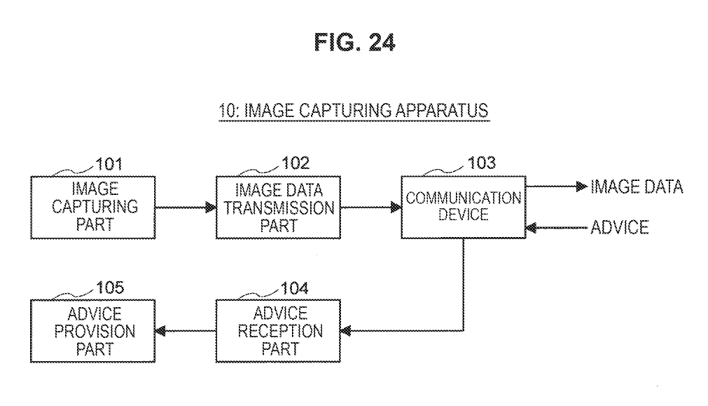

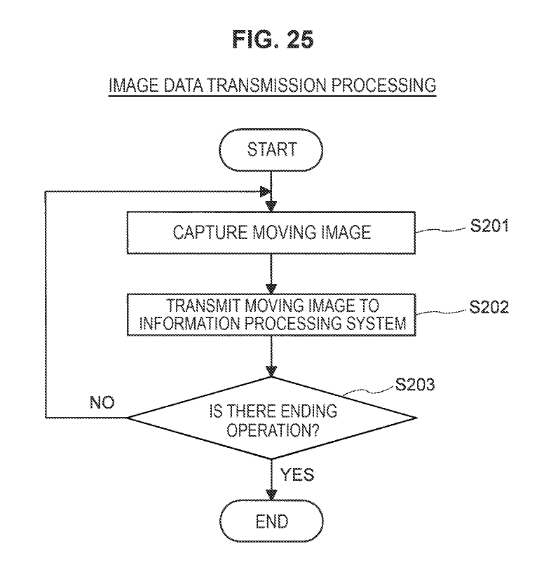

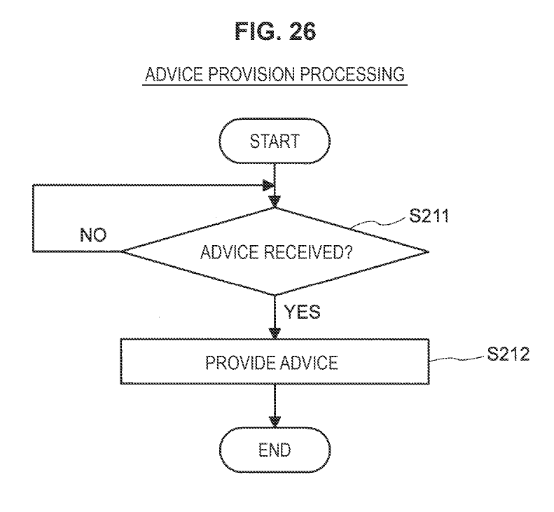

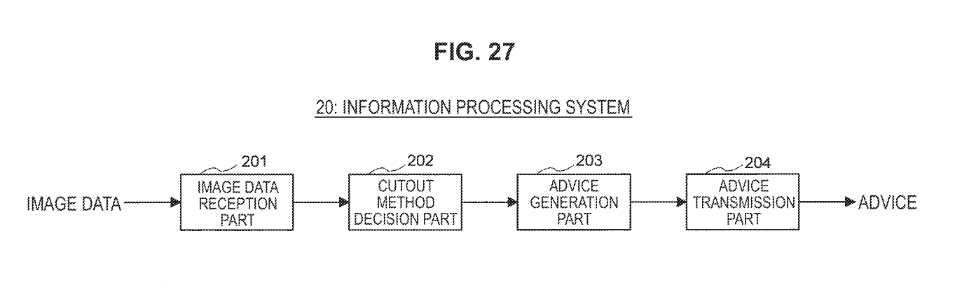

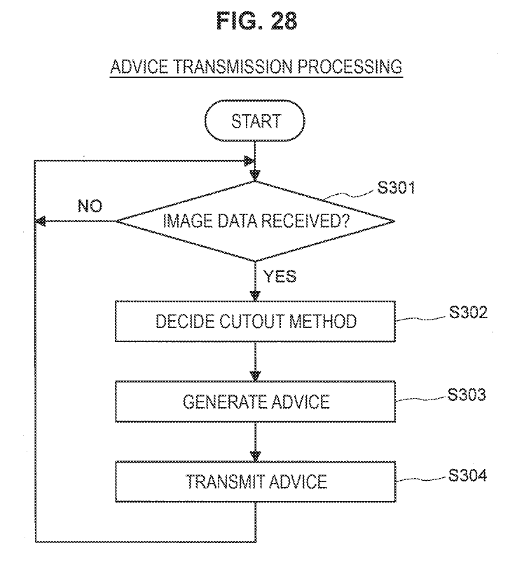

Next, a functional configuration of an image capturing apparatus 10 capable of realizing a composition advice provision method to which the composition determination technique according to the embodiment is applied is described with reference to FIG. 24. Next, operation of the image capturing apparatus 10 capable of realizing the composition advice provision method to which the composition determination technique according to the embodiment is applied is described with reference to FIG. 25 and FIG. 26. Next, a functional configuration of an information processing system 20 capable of realizing the composition advice provision method to which the composition determination technique according to the embodiment is applied is described with reference to FIG. 27. Next, operation of the information processing system 20 capable of realizing the composition advice provision method to which the composition determination technique according to the embodiment is applied is described with reference to FIG. 28.

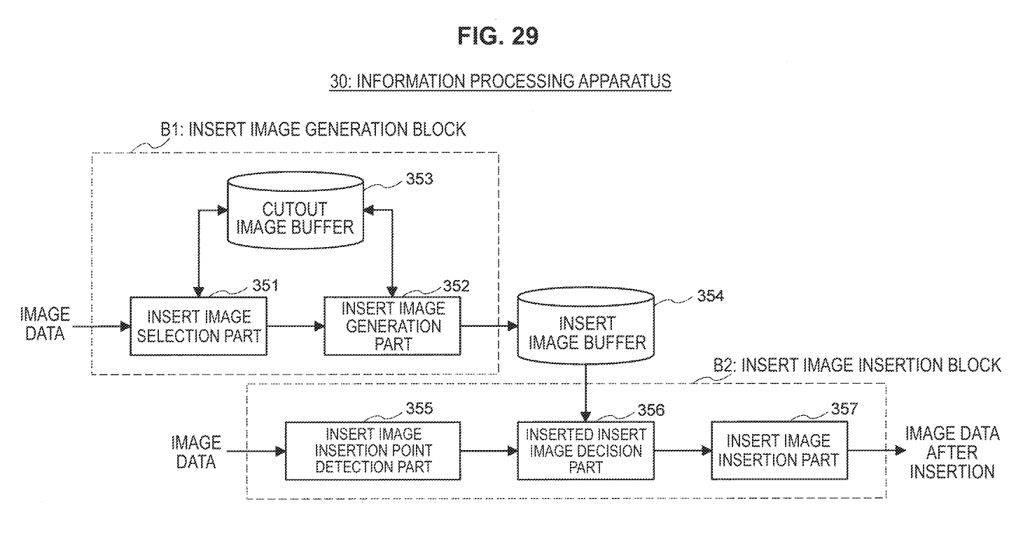

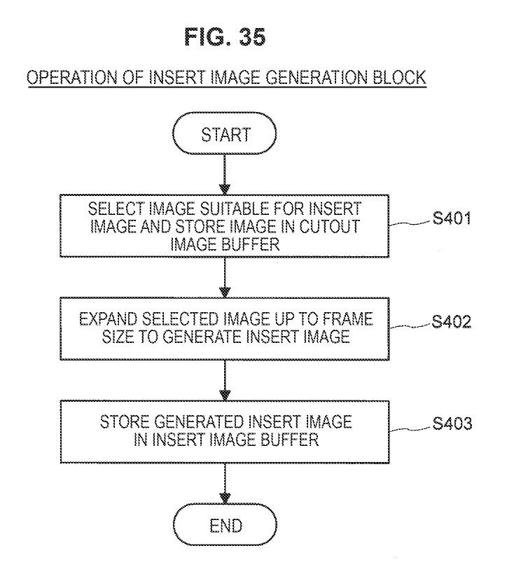

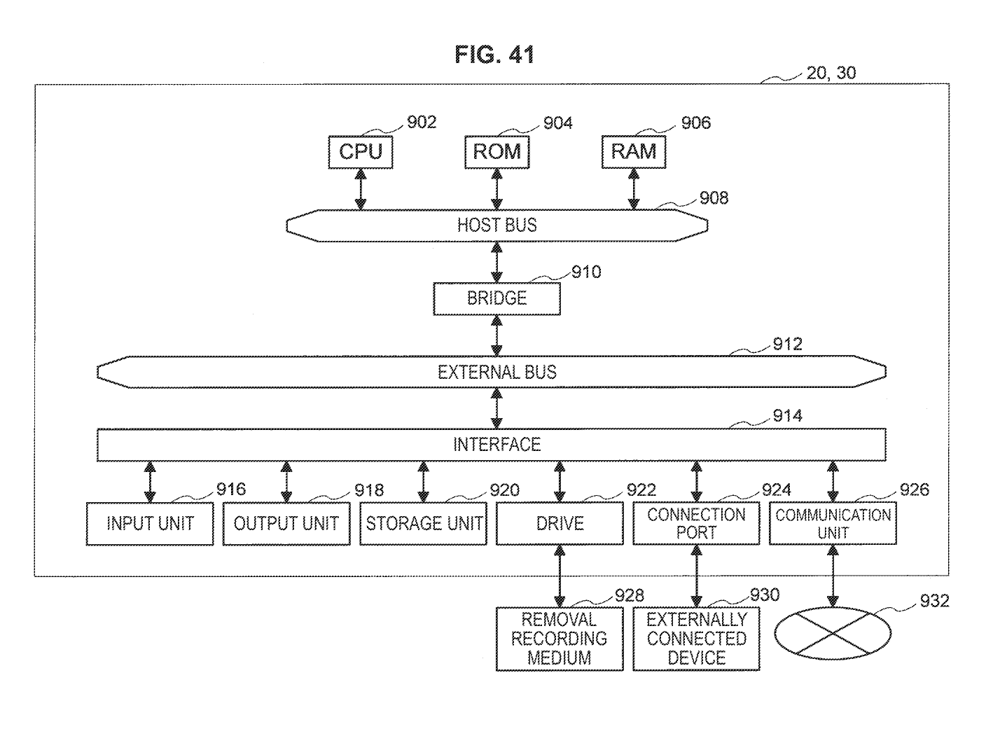

Next, a functional configuration of an information processing apparatus 30 capable of realizing the insert shot image insertion technique according to the embodiment is described with reference to FIG. 29 to FIG. 34. Next, operation of the information processing apparatus 30 capable of realizing the insert shot image insertion technique according to the embodiment is described with reference to FIG. 35 to FIG. 40. Next, an example hardware configuration of an apparatus and a system capable of realizing the composition determination technique and insert shot image insertion technique according to the embodiment is described with reference to FIG. 41. Last, the technical spirit of the embodiments is summarized, and effects attained based on the technical spirit are described simply.

(Described Items)

### 1: Introduction

### 1-1: Motion Detection Technique of a Plurality of Objects

### 1-2: Overview of Composition Determination Technique

### 1-3: Overview of Insert Shot Image Insertion Technique

### 1-4: System Configuration

### 2: Details of Composition Determination Technique

### 2-1: Configuration of Information Processing Apparatus 30 (Exemplary Configuration #1)

### 2-2: Operation of Information Processing Apparatus 30

### 2-3: Application Example #1 (Configuration Utilizing Motion Information of Codec)

### 2-4: Application Example #2 (Configuration Utilizing Image Obtained by Wide-Angle Image Capturing)

### 2-5: Application Example #3 (Composition Advice Function)

### 2-5-1: Configuration of Image Capturing Apparatus 10

### 2-5-2: Operation of Image Capturing Apparatus 10

### 2-5-3: Configuration of Information Processing System 20

### 2-5-4: Operation of Information Processing System 20

### 3: Details of Insert Shot Image Insertion Technique

### 3-1: Configuration of Information Processing Apparatus 30 (Exemplary Configuration #2)

### 3-2: Operation of Information Processing Apparatus 30

### 3-3: Application Example #1 (Decision Method of Insertion Position Considering Voice)

### 3-4: Application Example #2 (Selection Method of Insert Image Considering Tone of Color)

### 4: Example Hardware Configuration

### 5: Conclusion

### 1: INTRODUCTION

First of all, a motion detection technique of a plurality of objects related to a composition determination technique and an insert shot image insertion technique according to the embodiment is introduced. Moreover, the overview of the composition determination technique and insert shot image insertion technique according to the embodiment is described.

[1-1: Motion Detection Technique of a Plurality of Objects (FIG. 1 and FIG. 2)]

At first, the motion detection technique of a plurality of objects is described with reference to FIG. 1 and FIG. 2. FIG. 1 and FIG. 2 are explanatory drawings for explaining the motion detection technique of a plurality of objects.

This technique is a technique of calculating, in the case of a moving image frame including a plurality of objects (persons M1 and M2 in the example of FIG. 1), motion vectors of individual objects (ObjectMV1 and ObjectMV2 in the example of FIG. 1). As the technique of detecting the motion vectors, a block matching method or the like is often used, for example.

Using such a technique enables to detect the motion vectors for individual blocks constituting the moving image frame (hereinafter referred to as LMVs). Furthermore, a number of LMVs thus detected undergo clustering, a representative of LMVs belonging to each cluster (each of Clusters #1 to #3 in the example of FIG. 2) is extracted as ObjectMV, and thereby, the motion vector for each object can be obtained. In the present description, such a technique is referred to as the motion detection technique of a plurality of objects.

As above, the motion detection technique of a plurality of objects has been described.

[1-2: Overview of Composition Determination Technique (FIG. 3)]

Next, the overview of the composition determination technique according to the embodiment with reference to FIG. 3. FIG. 3 is an explanatory drawing for explaining the overview of the composition determination technique according to the embodiment.

The composition determination technique according to the embodiment relates to a technique of deciding preferred composition in consideration of motion of an object (person M1 in the example of FIG. 3) and cutting out a region suitable for the composition. For example, in the example of FIG. 3, the object M1 is located in the vicinity of the center of the frame and is moving in the right direction. Motion of the object M1 is detected based on a motion vector ObjectMV1. At this stage, in the composition determination technique according to the embodiment, a cutout range is decided such that a space is made in the motion direction of the object M1, for example. Then, the cutout range is cut out, undergoes processing such as size adjustment, and after that, is substituted for the original moving image frame.

The composition determination technique according to the embodiment features a decision method of a cutout range in consideration of motion of each object. Moreover, in the composition determination technique according to the embodiment, deciding the cutout range in consideration of motion vectors of individual objects in the case of the plurality of the objects included in the moving image frame is also kept in mind. To realize such a decision method, the above-mentioned motion detection technique of a plurality of objects is utilized. The cutout method of making a space in the motion direction is herein introduced, whereas various kinds of composition can be realized by using the motion vector for each object. Other cutout patterns will be described in detail with specific examples later. Moreover, a mechanism will also be introduced in which information of the preferred composition decided using the composition determination technique according to the embodiment is provided to the user.

As above, the overview of the composition determination technique according to the embodiment has been described.

[1-3: Overview of Insert Shot Image Insertion Technique (FIG. 4)]

Next, the overview of the insert shot image insertion technique according to the embodiment is described with reference to FIG. 4. FIG. 4 is an explanatory drawing for explaining the overview of the insert shot image insertion technique according to the embodiment.

The insert shot image insertion technique according to the embodiment relates to a technique of automatically cutout material for an image used for an insert shot (hereinafter referred to as an insert image) from the moving image frame and processing the material to generate the insert image. For example, as illustrated in FIG. 4, a part of the region not including the primary objects (persons M1 to M3 in the example of FIG. 4) is configured as a cutout range used for material for the insert image. At this time, the cutout range is set to the shape in the same aspect ratio as that of the moving image frame, for example. Moreover, the image in this cutout range is cut out and expanded up to the size of the moving image frame to generate the insert image. Then, this insert image is inserted at a point such as a scene change. Described in detail later, the insert shot image insertion technique according to the embodiment is a technique including automatic generation of the insert image, automatic detection of the point at which the insert shot is to be inserted, and automatic insertion of the insert image.

As above, the overview of the insert shot image insertion technique according to the embodiment has been described.

[1-4: System Configuration (FIG. 5)]

Next, an exemplary configuration of a system to which the composition determination technique and insert shot image insertion technique according to the embodiment can be applied is described with reference to FIG. 5. FIG. 5 is an explanatory drawing for explaining the exemplary configuration of the system to which the composition determination technique and insert shot image insertion technique according to the embodiment can be applied. However, the system configuration herein introduced is one example and can be modified variously according to an embodiment of the present disclosure.

As illustrated in FIG. 5, this system includes an image capturing apparatus 10, an information processing system 20, an information processing apparatus 30 and the like, for example. The image capturing apparatus 10 is a device capturing moving images. Moreover, the information processing system 20 is a cloud computing system or a server system which is connected to the image capturing apparatus 10 via a network, for example. Moreover, the information processing apparatus 30 is a device such as a personal computer, an information terminal and a game machine. In addition, the description is hereafter made, supposing that video data captured by the image capturing apparatus 10 is processed mainly by the information processing apparatus 30, for the convenience of the description below, whereas the system configuration may include the functions of the information processing apparatus 30 which are implemented in the information processing system 20, and vice versa. Moreover, the information processing apparatus 30 may be constituted of a plurality of apparatuses.

As above, the exemplary configuration of the system to which the composition determination technique and insert shot image insertion technique according to the embodiment can be applied has been described. Herein, an example system configuration including the apparatus and system performing the composition determination technique and insert shot image insertion technique according to the embodiment is presented, whereas the system may further include a terminal apparatus acquiring and playing back moving images to which the composition determination results is reflected. Similarly, the system may include a terminal apparatus acquiring and playing back moving images in which insert shots are inserted based on the insert shot image insertion technique.

As above, the overview of the primary techniques according to the embodiment, and the like, have been described. The composition determination technique and insert shot image insertion technique according to the embodiment are described below more in detail one by one.

### 2: DETAILS OF COMPOSITION DETERMINATION TECHNIQUE

Hereinafter, the composition determination technique according to the embodiment is described.

[2-1: Configuration of Information Processing Apparatus 30 (Exemplary Configuration #1; FIG. 6 to FIG. 19)]

At first, a configuration of the information processing apparatus 30 capable of realizing the composition determination technique according to the embodiment is described with reference to FIG. 6. FIG. 6 is an explanatory drawing for explaining the configuration of the information processing apparatus 30 capable of realizing the composition determination technique according to the embodiment.

As illustrated in FIG. 6, the information processing apparatus 30 mainly includes a subject region detection part 301, a per-object motion detection part 302, a cutout region decision part 303, a cutout pattern database 304 and a cutout part 305.

Upon starting composition determination processing, at first, a CUR image corresponding to a current moving image frame is inputted to the subject region detection part 301, per-object motion detection part 302, cutout region decision part 303 and cutout part 305. Moreover, a REF image corresponding to a reference frame used for motion detection is inputted to the per-object motion detection part 302. The subject region detection part 301 detects a region including the subject (hereinafter referred to as a subject region) from the CUR image using subject detection techniques (also including object recognition, face recognition, face tracking and the like). Information of the subject region (hereinafter referred to as subject region information) detected by the subject region detection part 301 is inputted to the cutout region decision part 303.

On the other hand, the per-object motion detection part 302 to which the CUR image and REF image are inputted detects a motion vector ObjectMV of each object using the inputted CUR image and REF image. Information of the motion vector ObjectMV of each object (hereinafter referred to as ObjectMV information) detected by the per-object motion detection part 302 is inputted to the cutout region decision part 303.

As above, the CUR image, subject region information and ObjectMV information are inputted to the cutout region decision part 303. When these pieces of information are inputted, the cutout region decision part 303 decides a cutout region based on the inputted information. At this stage, the cutout region decision part 303 decides the cutout region based on information of a cutout pattern read out from the cutout pattern database 304. The cutout pattern is information for regulating cutout conditions which are on the basis of arrangement and motion orientation of objects such, for example, as “composition making a space in the object motion direction of an object”, “trichotomy composition” and “enclosure composition”.

Information of the cutout region decided by the cutout region decision part 303 is inputted to the cutout part 305. When the information of the cutout region is inputted, the cutout part 305 cuts out a partial region from the CUR image according to the inputted information of the cutout region to generated a cutout image. The cutout image generated by the cutout part 305 is outputted from the information processing apparatus 30. For example, the cutout image is provided to a terminal apparatus (not shown), the image capturing apparatus 10 or the like. Moreover, the cutout image is expanded to the size of the moving image frame, and after that, inserted into the original moving image in place of the CUR image.

As above, the configuration of the information processing apparatus 30 has been roughly described. Hereafter, main constituents of the information processing apparatus 30 are described more in detail.

(Details of Subject Region Detection Part 301)

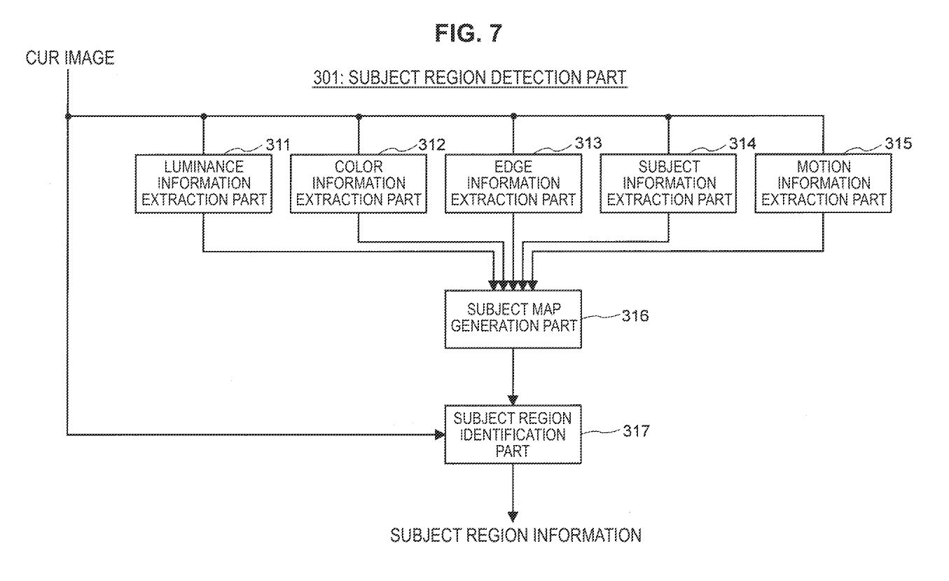

At first, a configuration of the subject region detection part 301 is described more in detail with reference to FIG. 7. FIG. 7 is an explanatory drawing for explaining the configuration of the subject region detection part 301 more in detail.

As illustrated in FIG. 7, the subject region detection part 301 mainly includes a luminance information extraction part 311, a color information extraction part 312, an edge information extraction part 313, a subject information extraction part 314, a motion information extraction part 315, a subject map generation part 316 and a subject region identification part 317.

When the CUR image is inputted to the subject region detection part 301, the inputted CUR image is inputted to the luminance information extraction part 311, color information extraction part 312, edge information extraction part 313, subject information extraction part 314, motion information extraction part 315 and subject region identification part 317. The luminance information extraction part 311 extracts luminance information from the CUR image and inputs it to the subject map generation part 316. The color information extraction part 312 extracts color information from the CUR image and inputs it to the subject map generation part 316. The edge information extraction part 313 extracts edge information from the CUR image and inputs it to the subject map generation part 316. The subject information extraction part 314 extracts subject information from the CUR image and inputs it to the subject map generation part 316. The motion information extraction part 315 extracts motion information from the CUR image and inputs it to the subject map generation part 316.

When the luminance information, color information, edge information, subject information and motion information are inputted, the subject map generation part 316 generates a subject map using the inputted luminance information, color information, edge information, subject information and motion information. The subject map generated by the subject map generation part 316 is inputted to the subject region identification part 317. When the subject map is inputted, the subject region identification part 317 identifies regions corresponding to individual subjects (subject regions) based on the inputted CUR image and subject map, and outputs subject region information.

As above, the configuration of the subject region detection part 301 has been described.

(Details of Per-Object Motion Detection Part 302)

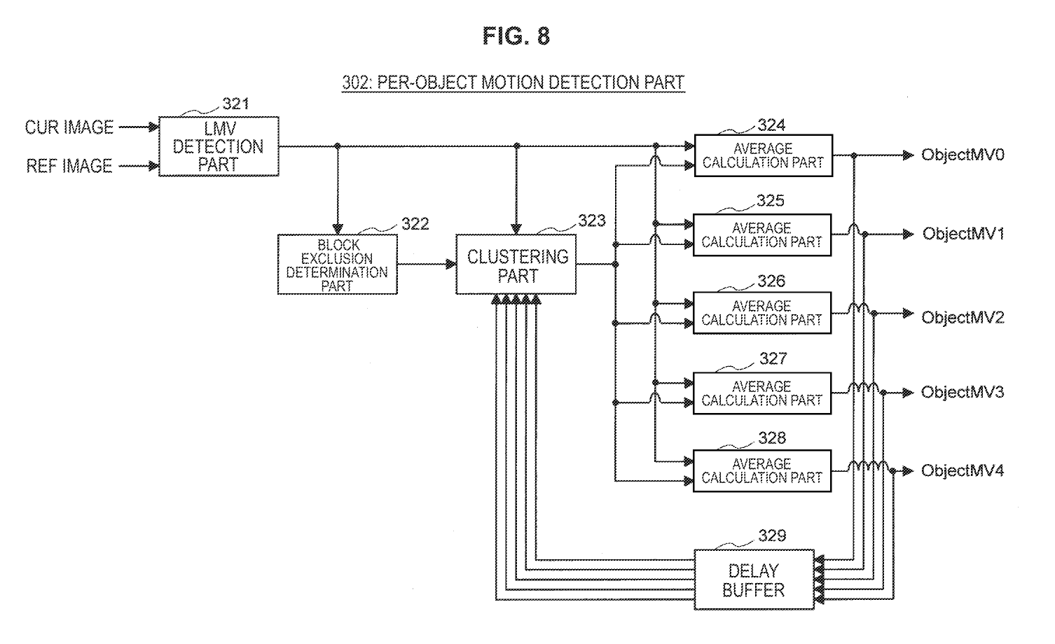

Next, a configuration of the per-object motion detection part 302 is described more in detail with reference to FIG. 8. FIG. 8 is an explanatory drawing for explaining the configuration of the per-object motion detection part 302 more in detail.

As illustrated in FIG. 8, the per-object motion detection part 302 mainly includes an LMV detection part 321, a block exclusion determination part 322, a clustering part 323, average calculation parts 324, 325, 326, 327 and 328, and a delay buffer 329.

When the CUR image and REF image are inputted to the per-object motion detection part 302, the inputted CUR image and REF image are inputted to the LMV detection part 321. The LMV detection part 321 detects LMVs using the CUR image and REF image. For example, the LMV detection part 321 detects an LMV for each block using a technique such as a block matching method. The LMVs detected by the LMV detection part 321 are inputted to the block exclusion determination part 322, clustering part 323, and average calculation parts 324, 325, 326, 327 and 328.

When the LMVs are inputted, the block exclusion determination part 322 determines a DR (Dynamic Range) and an SAD (Sum of Absolute Difference) in block unit, and unnecessary blocks (hereinafter referred to as exclusion blocks) not used for clustering based on the coordinates of the blocks. Information of blocks determined as the unnecessary blocks by the block exclusion determination part 322 is inputted to the clustering part 323. When the information of the exclusion blocks is inputted, the clustering part 323 performs clustering processing on LMVs, setting the LMVs other than LMVs corresponding to the exclusion blocks as the objects.

Results of the clustering by the clustering part 323 are inputted to the average calculation parts 324, 325, 326, 327 and 328. The average calculation part 324 calculates an average value of LMVs belonging to cluster #0, and outputs the calculated average value as ObjectMV0. In addition, #0 to #4 are numbers attached simply for convenience. Moreover, it is supposed that the number of clusters is herein 5 for the convenience of description, whereas it is recommended that the number and configuration of the average calculation parts are changed appropriately in case of the number of clusters exceeding 5.

Similarly, the average calculation part 325 calculates an average value of LMVs belonging to cluster #1, and outputs the calculated average value as ObjectMV1. The average calculation part 326 calculates an average value of LMVs belonging to cluster #2, and outputs the calculated average value as ObjectMV2. The average calculation part 327 calculates an average value of LMVs belonging to cluster #3, and outputs the calculated average value as ObjectMV3. The average calculation part 328 calculates an average value of LMVs belonging to cluster #4, and outputs the calculated average value as ObjectMV4.

Moreover, ObjectMV0 to ObjectMV4 outputted from the average calculation parts 324, 325, 326, 327 and 328 are stored in the delay buffer 329. ObjectMV0 to ObjectMV4 stored in the delay buffer 329 are read out by the clustering part 323, and used in next performing clustering processing. For example, a representative vector (ObjectMV) of each cluster extracted in previous clustering processing is utilized in the case of performing hierarchical clustering, which is described later, and the like.

As above, the configuration of the per-object motion detection part 302 has been described.

(Details of Cutout Region Decision Part 303)

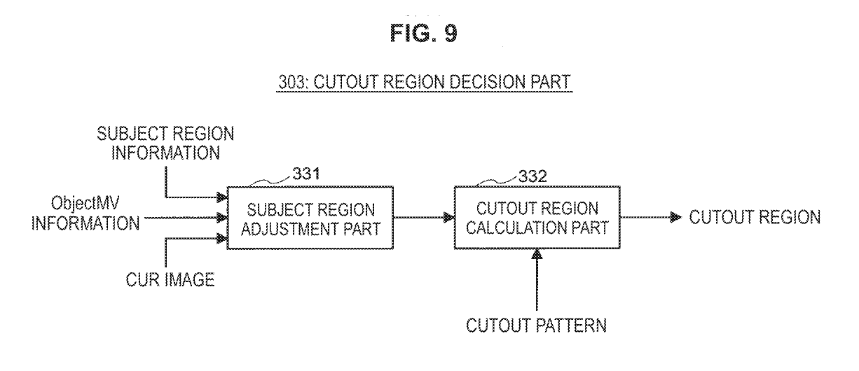

Next, the configuration of the cutout region decision part 303 is described more in detail with reference to FIG. 9 to FIG. 14. FIG. 9 to FIG. 14 are explanatory drawings for explaining the configuration of the cutout region decision part 303 more in detail.

As illustrated in FIG. 9, the cutout region decision part 303 mainly includes a subject region adjustment part 331 and a cutout region calculation part 332.

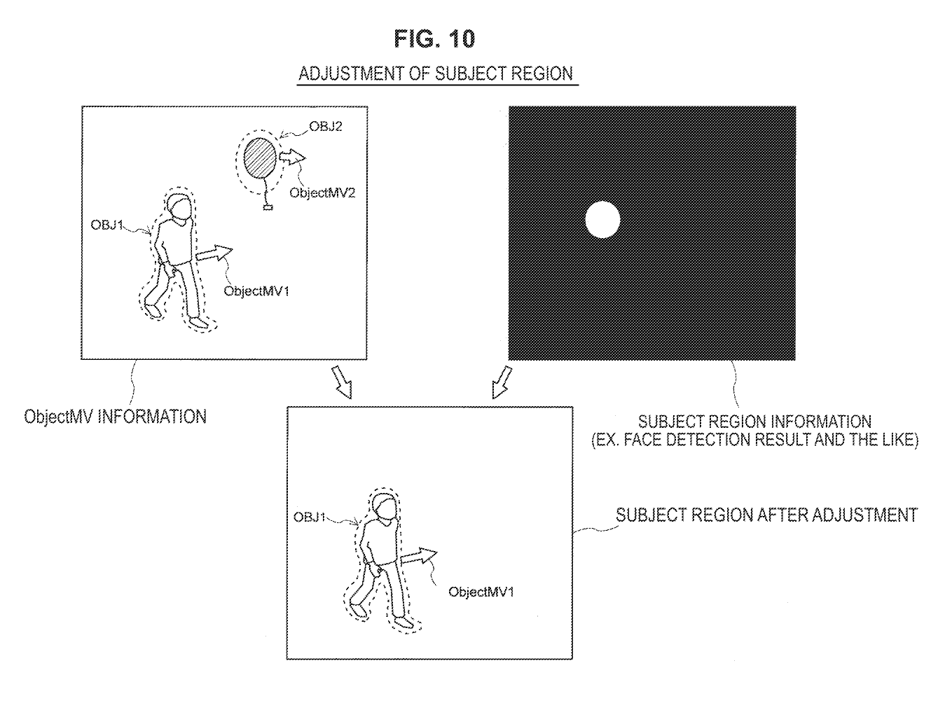

When the subject region information, ObjectMV information and CUR image are inputted to the cutout region decision part 303, the inputted subject region information, ObjectMV information and CUR image are inputted to the subject region adjustment part 331. When these pieces of information are inputted, as illustrated in FIG. 10, the subject region adjustment part 331 compares the subject region recognized from the ObjectMV information with the subject region indicated by the subject region information, and adjusts the subject region according to the comparison result.

In the example of FIG. 10, the subject regions corresponding to two objects OBJ1 and OBJ2 are recognized from the ObjectMV information. On the other hand, based on the subject region information, the face region of the object OBJ1 detected by face recognition is obtained as a subject region, as one example. In this case, the subject region adjustment part 331 extracts one including the subject region indicated by the subject region information out of the two subject regions indicated by the ObjectMV information, and recognizes it as a subject region after adjustment. Performing such adjustment enables cutting out the region in which the person is the subject higher in accuracy, for example.

In the above-mentioned example, a method of comparing ObjectMV information with a result of face recognition is presented, whereas using a detection result of a portion other than the face (hand, upper half of the body or the like), for example, can also afford the similar effect. Moreover, a method can also be considered in which a region having been excluded in the ObjectMV information is supplemented using the subject region information. For example, it is sometimes the case that, when a person in plain colored clothes is set as a subject, the clothes portion is excluded from the subject region in the ObjectMV information. When such an excluded region is detected in the subject region information, the subject region adjustment part 331 adjusts the subject region so as to include the subject region identified by the subject region information.

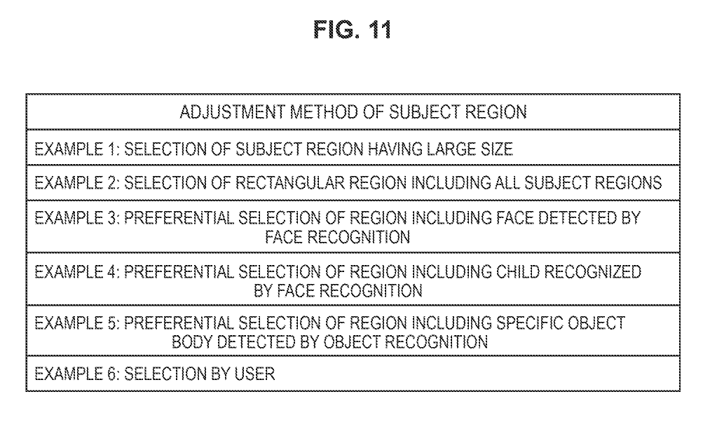

Thus, comparing the position of the subject region determined from the ObjectMV information with the position of the subject region detected by subject detection enables enhanced detection accuracy of the subject region. In addition, various methods as illustrated in FIG. 11 can be considered as the adjustment method of the subject region other than the method exemplified in FIG. 10. Especially, the methods illustrated in FIG. 11 are applied to the case where both of the subject regions of the objects OBJ1 and OBJ2 illustrated in FIG. 10, for example, are detected, or the like. For example, the methods can be considered (example 1) in which the subject region having the large size is selected and set as the subject region after adjustment, (example 2) in which a rectangular region including all the subject regions is set as the subject region after adjustment, (example 3) in which the region including the face detected by face recognition is preferentially set as the subject region after adjustment, and the like.

Other than these, the methods can also be considered (example 4) in which the region including its own child recognized by face recognition is preferentially set as the subject region after adjustment, (example 5) in which a region including a specific object body detected by object recognition is preferentially set as the subject region after adjustment, (example 6) in which candidates for the subject region are provided to the user and the user is allowed to select the subject region after adjustment, and the like. Thus, the information of the subject region adjusted by the subject region adjustment part 331 is inputted to the cutout region calculation part 332. When the information of the subject region is inputted, the cutout region calculation part 332 calculates a cutout region based on the information of a cutout pattern read out from the cutout pattern database 304.

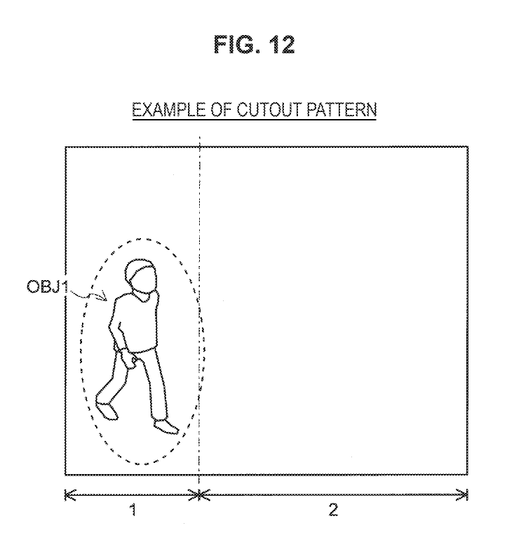

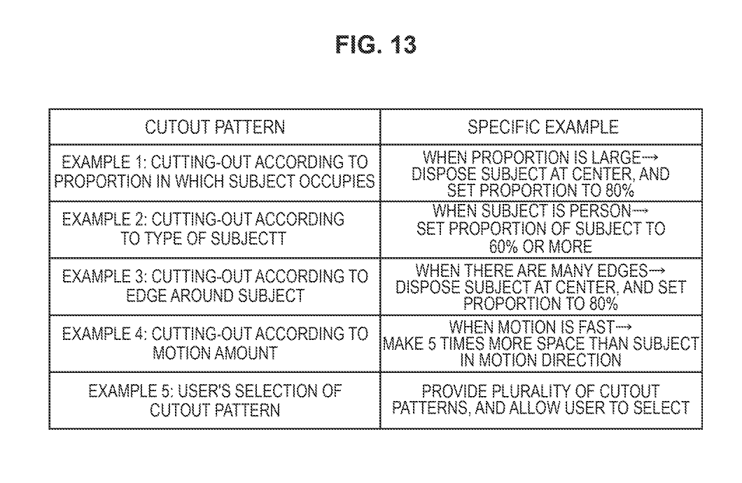

For example, when “trichotomy composition” is selected as the cutout pattern, the cutout region calculation part 332 calculates the cutout region such that the object OBJ1 as the subject falls in a range of one third of the screen from its left side as illustrated in FIG. 12. In addition, various patterns as illustrated in FIG. 13, for example, can be considered other than “trichotomy composition” as the cutout pattern. For example, (example 1) a cutout pattern according to a proportion in which the subject occupies, (example 2) a cutout pattern according to a type of the subject, (example 3) a cutout pattern according to an edge around the subject, (example 4) a cutout pattern according to a motion amount, (example 5) a method of providing cutout patterns and allowing the user to select one, and the like can also be considered. In addition, the method such as (example 2) expects processing such as face recognition, whereas the known face recognition method can be used for it.

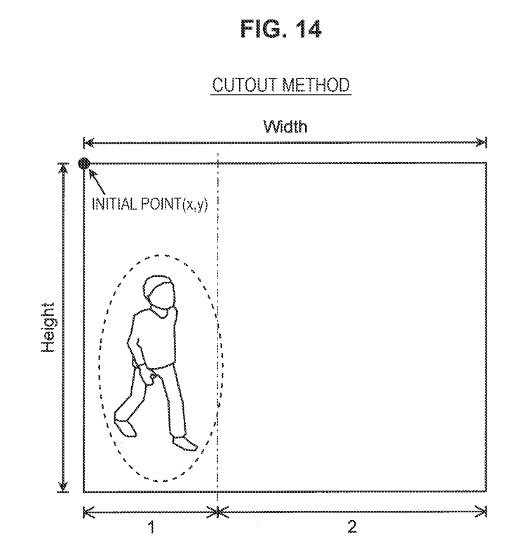

Moreover, when the cutout region is decided, the cutout region calculation part 332 calculates values of the coordinates of the top left corner of the cutout region (initial point (x, y)), the width Width of the cutout region, the height Height of the cutout region, and the like as illustrated in FIG. 14. The values defining the cutout region, which values are thus calculated, are inputted to the cutout part 305.

(Supplemental Description Regarding Decision Method of Cutout Region)

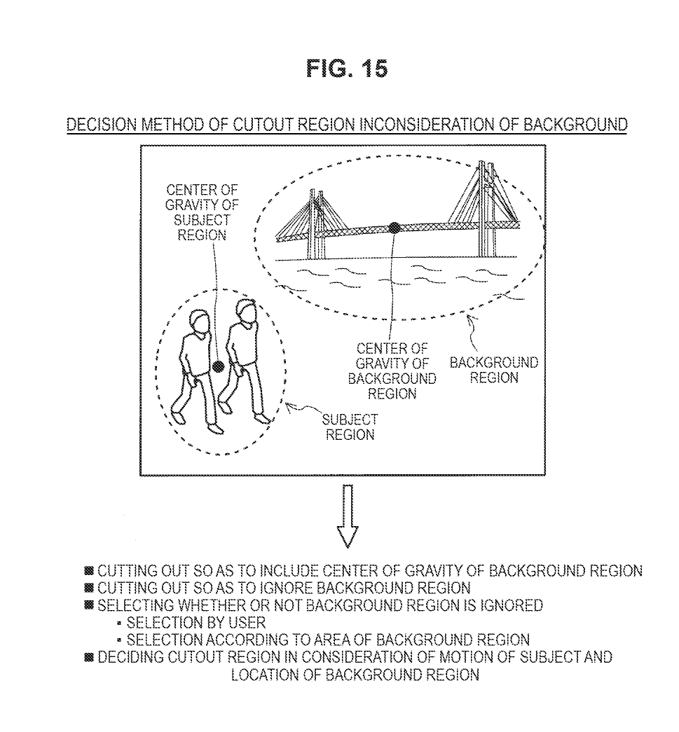

Herein, description of the decision methods of the cutout region is supplemented with reference to FIG. 15 to FIG. 19. FIG. 15 to FIG. 19 are explanatory drawings for supplementing the explanation of the decision methods of the cutout region.

At first, FIG. 15 is referred to. As illustrated in FIG. 15, when the subject and background are included in the CUR image, a decision method of the cutout region is considered in which the background is considered. For example, a method of cutting out can be considered such that the center of gravity of a region including the background (hereinafter referred to as a background region) is included. Moreover, a method of cutting out can also be considered such that the background region is ignored. Moreover, a method of cutting out can also be considered in which whether the background region is ignored or not is selected and the cutout pattern according to the selection result is used. The selection can include, for example, a method of the user allowed to select, a method of performing selection according the area of the background region, and the like. Moreover, a method can also be considered in which the cutout region is decided in consideration of motion of the subject and location of the background region.

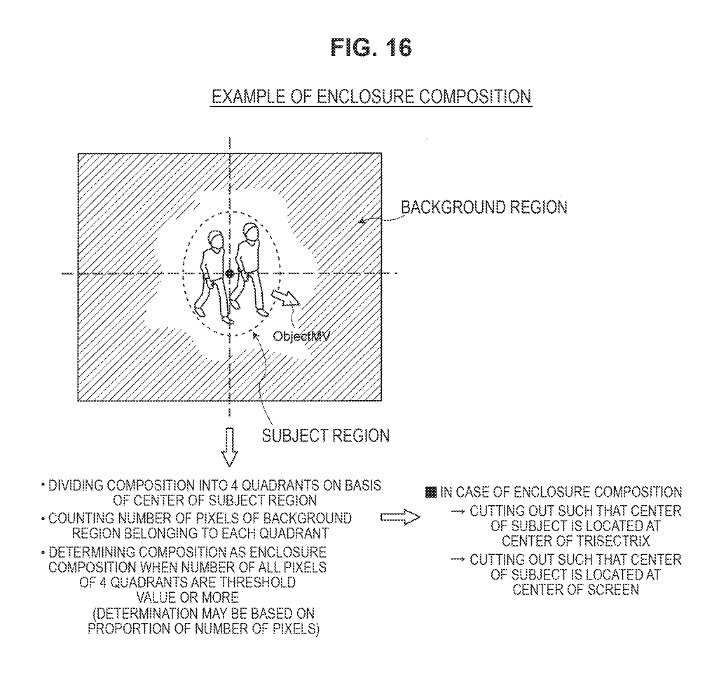

Next, FIG. 16 is referred to. As illustrated in FIG. 16, it is sometimes the case that selection of “enclosure composition” as the cutout pattern is suitable. A method of determining enclosure composition can include the following method, for example. At first, the image is divided into 4 quadrants on the basis of the center of the subject region, and the number of pixels of the background region belonging to each quadrant is counted. Then, when the number of pixels of the background region are a predetermined threshold value or more for all of the 4 quadrants, it is determined that the enclosure composition is suitable. In addition, the determination of the enclosure composition is similarly possible also in case of proportions of the number of pixels in place of the values of the number of pixels as the object for the threshold determination. When it is determined that the enclosure composition is suitable, methods are applied in which cutting out is performed such that the center of the subject is located at the center of the trisectrix, in which cutting out is performed such that the center of the subject is located at the center of the screen, and the like.

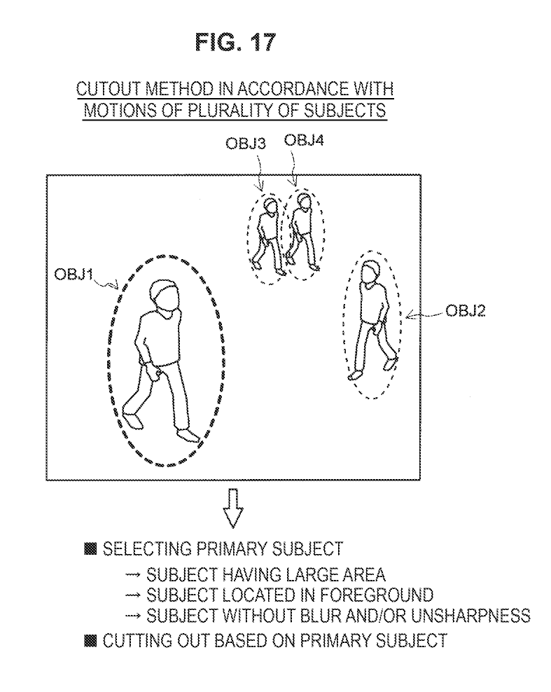

Next, FIG. 17 is referred to. As illustrated in FIG. 17, a cutout method according to motions of a plurality of subjects can also be considered. In this case, the method is applied in which the primary subject is selected and the cutout region is decided on the basis of the primary subject. Selection criteria of the primary subject can include the subject having a large area, the subject located in the foreground, the subject without blur or unsharpness, and the like, for example. In the example of FIG. 17, the object OBJ1 having the largest area is selected as the primary subject, and the cutout region is decided on the basis of the object OBJ1, for example.

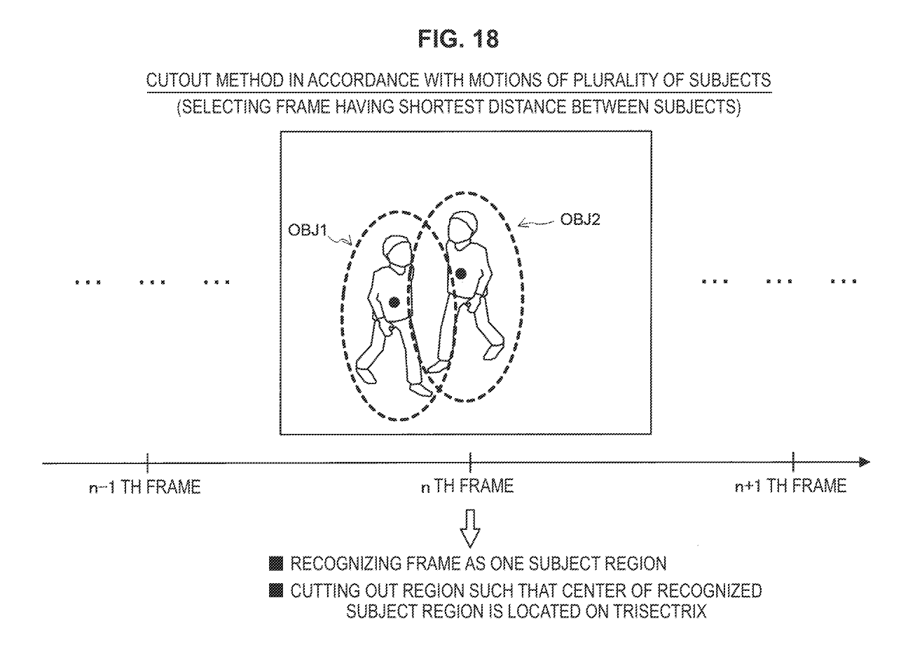

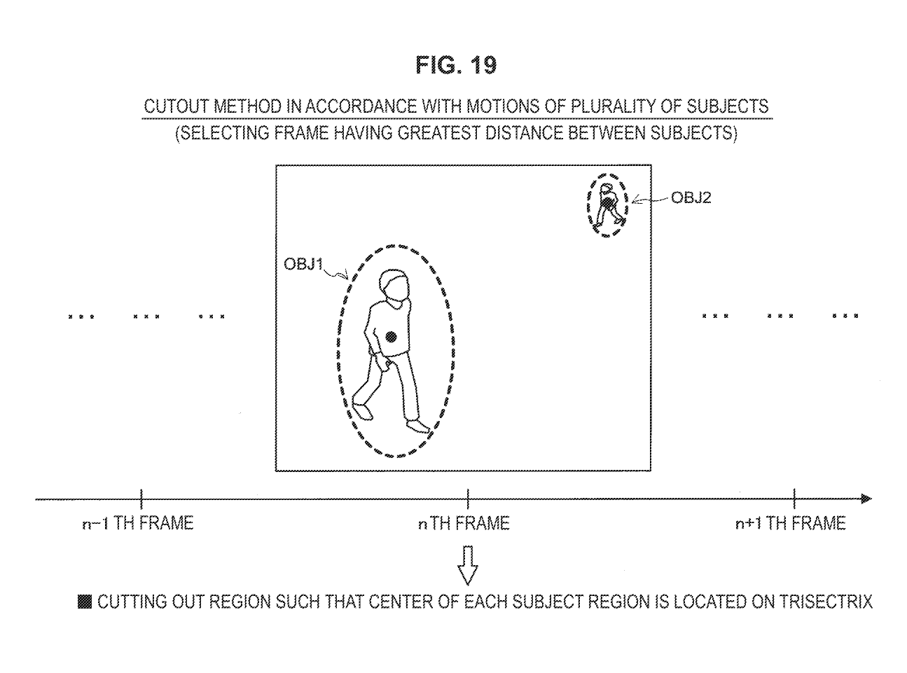

Next, FIG. 18 and FIG. 19 are referred to. It has not been considered so far which moving image frame in the moving image is used for the CUR image to be cut out. Herein, this point is described. As illustrated in FIG. 18, one method is considered to be a method in which the moving image frame having the shortest distance between subjects is selected and the selected moving image frame is set as the cutout object. In this case, a method of cutting out can be considered in which a plurality of subjects approaching each other are recognized as one subject region and, for example, the center of the recognized subject region is set so as to fall on the trisectrix. Conversely, as illustrated in FIG. 19, a method can also be considered in which the moving image frame having the greatest distance between subjects is set as the cutout object. In this case, a method of cutting out can be considered in which the center of each subject region is set so as to fall in the trisectrix, for example.

As above, various cutout methods can be applied.

As above, the functional configuration of the information processing apparatus 30 has been described in detail.

[2-2: Operation of Information Processing Apparatus 30 (FIG. 20 to FIG. 23)]

Next, operation of the information processing apparatus 30 is described with reference to FIG. 20 to FIG. 23. FIG. 20 to FIG. 23 are explanatory drawings for explaining the operation of the information processing apparatus 30.

(Overall Flow of Processing)

At first, an overall flow of processing is described. As illustrated in FIG. 20, the information processing apparatus 30 at first detects subject regions based on subject detection techniques (S101). Next, the information processing apparatus 30 detects motion vectors for individual objects (S102). Next, the information processing apparatus 30 decides a cutout region based on the motion vectors for individual objects, the detection results of the subject regions and a cutout pattern (S103). Next, the information processing apparatus 30 cuts out the cutout region decided in step S103 (S104), and ends the series of processes. In addition, the processes in steps S101 and S102 may be reversed in their order.

As above, the overall flow of the processing has been described.

(Flow of Processing According to Detection of Subject Region)

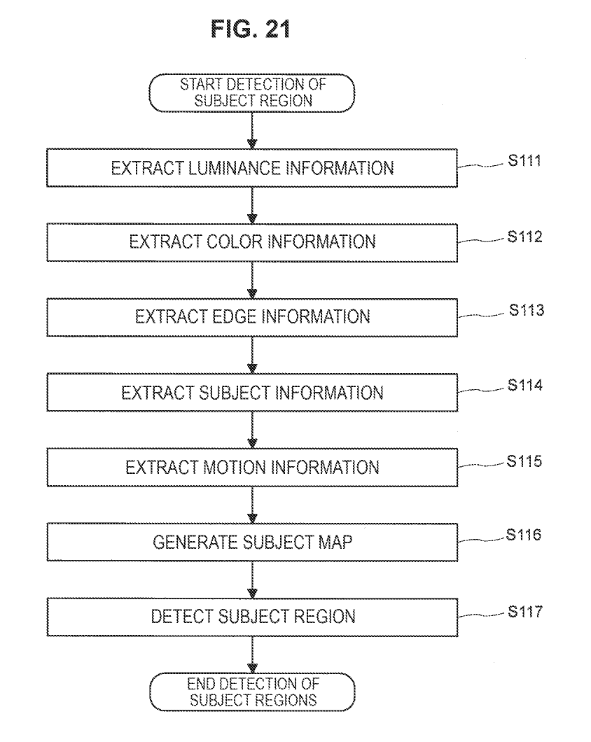

Next, a flow of processing according to detection of a subject region is described. As illustrated in FIG. 21, the information processing apparatus 30 at first extracts luminance information from a CUR image (S111). Next, the information processing apparatus 30 extracts color information from the CUR image (S112). Next, the information processing apparatus 30 extracts edge information from the CUR image (S113). Next, the information processing apparatus 30 extracts subject information from the CUR image (S114).

Next, the information processing apparatus 30 extracts motion information from the CUR image (S115). Next, the information processing apparatus 30 generates a subject map using the luminance information, color information, edge information, subject information and motion information (S116). Next, the information processing apparatus 30 detects a subject region using the subject map generated in step S116 (S117), and ends the series of processes according to the detection of the subject region.

As above, the flow of the processing according to the detection of the subject region has been described.

(Flow of Processing According to Motion Detection)

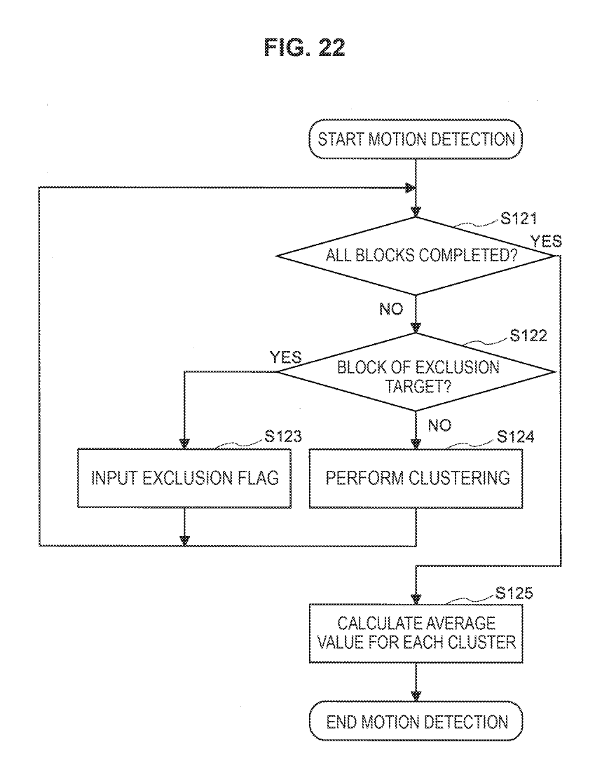

Next, a flow of processing according to motion detection is described. As illustrated in FIG. 22, the information processing apparatus 30 at first determines whether or not the processing is completed for all the blocks (S121). When the processing is completed for all the blocks, the information processing apparatus 30 puts the processing forward to step S125. On the other hand, when the process is not completed for all the blocks, the information processing apparatus 30 puts the processing forward to step S122.

When the processing is put forward to step S122, the information processing apparatus 30 determines whether or not a currently targeted block is a block of the exclusion target (S122). In the case of being a block of the exclusion target, the information processing apparatus 30 puts the processing forward to step S123. On the other hand, in the case of not being any block of the exclusion target, the information processing apparatus 30 puts the processing forward to step S124.

When the processing is put forward to step S123, the information processing apparatus 30 inputs an exclusion flag for the currently targeted block (S123), and puts the processing forward to step S121. On the other hand, when the processing is put forward to step S124, the information processing apparatus 30 performs clustering of LMVs (S 124), and puts the processing forward to step S121. When the processing is put forward to step S125 in step S121, the information processing apparatus 30 calculates an average value of the LMVs for each cluster (S125), and ends the series of processes according to the motion detection.

As above, the flow of the processing according to the motion detection has been described.

(Flow of Processing According to Decision of Cutout Region)

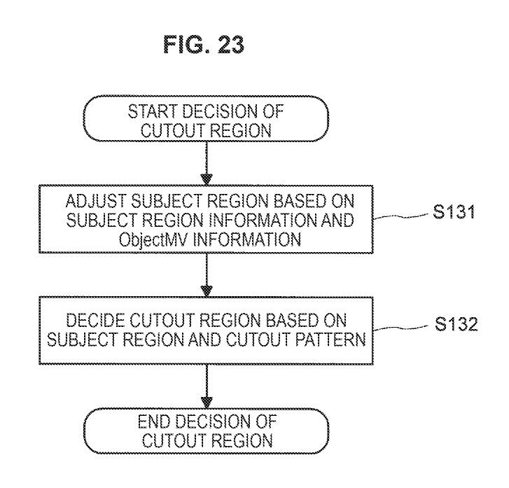

Next, a flow of processing according to decision of a cutout region is described. As illustrated in FIG. 23, the information processing apparatus 30 adjusts the subject region based on the subject region information and ObjectMV information (S131). Next, the information processing apparatus 30 decides a cutout region based on the subject region after the adjustment and a cutout pattern (S132), and ends the series of processes according to the decision of the cutout region.

As above, the flow of the processing according to the decision of the cutout region has been described.

As above, the operation of the information processing apparatus 30 has bee described.

[2-3: Application Example #1 (Configuration Utilizing Motion Information of Codec)]

Incidentally, the description has been made so far, supposing that the ObjectMV is calculated ab initio, whereas utilizing codec information included in the moving image can reduce calculation load of the ObjectMV. When the ObjectMV information is included in the codec information, the calculation step of the ObjectMV can be omitted of course by utilizing the information as it is, and therefore, the processing can be largely downsized. Moreover, when the information of LMVs is included in the codec information, the calculation step of the LMVs can be omitted in calculating the ObjectMV, and therefore, processing load and processing time can be reduced.

[2-4: Application Example #2 (Configuration Utilizing Image Obtained by Wide-Angle Image Capturing)]

Incidentally, when the CUR image is cut out so as to have preferred composition, its image size shrinks as a matter of course. Therefore, when the cutout image is inserted in the moving image, the cutout image is expected to be expanded up to the size of the moving image frame. At that time, the image quality deteriorates. Hence, when the composition determination technique according to the embodiment is applied, the image is desirable to be captured in high resolution. Capturing the image in high resolution can suppress the deterioration of the image quality. Moreover, beforehand preparing a moving image obtained by wide-angle image capturing expands the range in which the cutting-out is performed, therefore, realizable cutout patterns increases, and various kinds of composition can be made more flexibly.

[2-5: Application Example #3 (Composition Advice Function)]

Now, the methods of determining the cutout region so as to have composition corresponding to a cutout pattern to generate the cutout image from the CUR image has been described so far. However, the information of the cutout region which information is obtained in the process of generating the cutout image is useful information also for the image capturing person. Namely, the information of the cutout region can be utilized for determining in which composition the image is suitable to be captured. Therefore, the inventors have devised a mechanism of utilizing the information of the cutout region for advice of the composition. For example, the following configurations of the image capturing apparatus 10 and information processing system 20 enable to realize the composition advice function as mentioned above.

(2-5-1: Configuration of Image Capturing Apparatus 10 (FIG. 24))

At first, a functional configuration of the image capturing apparatus 10 in which a composition advice function is implemented is described with reference to FIG. 24. FIG. 24 is an explanatory drawing for explaining the functional configuration of the image capturing apparatus 10 in which the composition advice function is implemented.

As illustrated in FIG. 24, the image capturing apparatus 10 mainly includes an image capturing part 101, an image data transmission part 102, a communication device 103, an advice reception part 104 and an advice provision part 105.

The image capturing part 101 includes an optical system constituted of a zoom lens, a focus lens and the like, a solid-state image sensor such as CCD and CMOS, an image processing circuit performing A/D conversion on electric signals outputted from the solid-state image sensor to generate image data, and the like. The image data outputted from the image capturing part 101 is inputted to the image data transmission part 102. When the image data is inputted, the image data transmission part 102 transmits the image data to the information processing system 20 via the communication device 103. In addition, the communication device 103 may be configured to be detachable from the housing.

When information of composition advice is transmitted from the information processing system 20 having received the image data, the advice reception part 104 receives the information of composition advice via the communication device 103. The information of composition advice received by the advice reception part 104 is inputted to the advice provision part 105. When the information of composition advice is inputted, the advice provision part 105 provides the inputted information of composition advice to the user. For example, the advice provision part 105 displays a frame corresponding to the cutout region on a display part (not shown), and/or performs control to automatically drive a zoom mechanism such that the cutout region comes close to the image capturing region.

As above, the configuration of the image capturing apparatus 10 has been described.

(2-5-2: Operation of Image Capturing Apparatus 10 (FIG. 25 and FIG. 26))

Next, operation of the image capturing apparatus 10 in which the composition advice function is implemented is described with reference to FIG. 25 and FIG. 26. FIG. 25 and FIG. 26 are explanatory drawings for explaining the operation of the image capturing apparatus 10 in which the composition advice function is implemented.

At first, FIG. 25 is referred to. As illustrated in FIG. 25, the image capturing apparatus 10 having started the image data transmission processing captures image data of the moving image (S201). Next, the image capturing apparatus 10 transmits the image data of the moving image captured in step S201 to the information processing system 20 (S202). Next, the image capturing apparatus 10 determines whether or not there is an ending operation of the image data transmission processing (S203). When there is the ending operation, the image capturing apparatus 10 ends the series of processes according to the image data transmission processing. On the other hand, when there is no ending operation, the image capturing apparatus 10 puts the processing forward to step S201.

Next, FIG. 26 is referred to. As illustrated in FIG. 26, the image capturing apparatus 10 having started the advice provision processing, at first, determines whether or not the information of composition advice is received from the information processing system 20 (S211). When the information of composition advice is received, the image capturing apparatus 10 puts the processing forward to step S212. On the other hand, when the information of composition advice is not received, the image capturing apparatus 10 puts the processing forward to step S211. When the processing is put forward to step S212, the image capturing apparatus 10 provides the information of composition advice received from the information processing system 20 to the user (S212), and ends the series of processes according to the advice provision processing.

As above, the operation of the image capturing apparatus 10 has been described.

(2-5-3: Configuration of Information Processing System 20 (FIG. 27))

Next, a functional configuration of the information processing system 20 in which the composition advice function is implemented is described with reference to FIG. 27. FIG. 27 is an explanatory drawing for explaining the functional configuration of the information processing system 20 in which the composition advice function is implemented.

As illustrated in FIG. 27, the information processing system 20 mainly includes an image data reception part 201, a cutout method decision part 202, an advice generation part 203 and an advice transmission part 204.

The image data transmitted from the image capturing apparatus 10 is received by the image data reception part 201. The image data received by the image data reception part 201 is inputted to the cutout method decision part 202. When the image data is inputted, the cutout method decision part 202 detects the subject region information and ObjectMV information from the image data similarly to the above-mentioned information processing apparatus 30, and after adjustment of the subject region, decides the cutout region based on the cutout pattern. The information of the cutout region decided by the cutout method decision part 202 is inputted to the advice generation part 203.

When the information of the cutout region is inputted, the advice generation part 203 generates the information of composition advice based on the inputted information of the cutout region. For example, the advice generation part 203 generates the information of composition advice including information of the position, vertical and horizontal sizes, and the like of the cutout region. Or, the advice generation part 203 generates, from the information of the cutout region, the information of composition advice including content to be corrected regarding a zoom control value, inclination of the image capturing apparatus 10, orientation toward which the lens is to face, and the like.

The information of composition advice generated by the advice generation part 203 is inputted to the advice transmission part 204. When the information of composition advice is inputted, the advice transmission part 204 transmits the inputted information of composition advice to the image capturing apparatus 10.

As above, the configuration of the information processing system 20 has been described.

(2-5-4: Operation of Information Processing System 20 (FIG. 28))

Next, operation of the information processing system 20 in which the composition advice function is implemented is described with reference to FIG. 28. FIG. 28 is an explanatory drawing for explaining the operation of the information processing system 20 in which the composition advice function is implemented.

As illustrated in FIG. 28, the information processing system 20 having started the advice transmission processing, at first, determines whether or not the image data is received from the image capturing apparatus 10 (S301). When the image data is received, the information processing system 20 puts the processing forward to step S302. On the other hand, when the image data is not received, the information processing system 20 puts the processing forward to step S301. When the processing is put forward to step S302, the information processing system 20 decides the cutout method (S302). Next, the information processing system 20 generates the information of composition advice based on the cutout method decided in step S302 (S303). Next, the information processing system 20 transmits the information of composition advice generated in step S303 to the image capturing apparatus 10 (S304), and puts the processing forward to step S301.

As above, the operation of the information processing system 20 has been described.

As above, the details of the composition determination technique according to the embodiment have been described.

### 3: DETAILS OF INSERT SHOT IMAGE INSERTION TECHNIQUE

Next, the insert shot image insertion technique according to the embodiment is described. In addition, the insert shot image insertion technique herein described has a partially common portion with the above-mentioned composition determination technique regarding detection of a cutout region for cutting out material for an insert image using subject region information and ObjectMV information.

[3-1: Configuration of Information Processing Apparatus 30 (Exemplary Configuration #2; FIG. 29 to FIG. 34)]

At first, a functional configuration of the information processing apparatus 30 capable of realizing the insert shot image insertion technique according to the embodiment is described with reference to FIG. 29. FIG. 29 is an explanatory drawing for explaining the functional configuration of the information processing apparatus 30 capable of realizing the insert shot image insertion technique according to the embodiment.

As illustrated in FIG. 29, the information processing apparatus 30 mainly includes an insert image selection part 351, an insert image generation part 352, a cutout image buffer 353, an insert image buffer 354, an insert image insertion point detection part 355, an inserted insert image decision part 356 and an insert image insertion part 357.

In addition, hereafter, the insert image selection part 351, insert image generation part 352 and cutout image buffer 353 are sometimes referred to as an insert image generation block B1. Moreover, the insert image insertion point detection part 355, inserted insert image decision part 356 and insert image insertion part 357 are sometimes referred to as an insert image insertion block B2.

(Configuration of Insert Image Generation Block B1)

When the image data of the CUR image is inputted to the information processing apparatus 30, the inputted image data is inputted to the insert image selection part 351. When the image data is inputted, the insert image selection part 351 cuts out a part of the inputted image data to generate a cutout image used as material for the insert image. The cutout image generated by the insert image selection part 351 is inputted to the insert image generation part 352, and in addition, stored in the cutout image buffer 353. When the cutout image is inputted, the insert image generation part 352 expands the inputted cutout image up to the size of the moving image frame to generate the insert image. The insert image generated by the insert image generation part 352 is stored in the insert image buffer 354.

(Configuration of Insert Image Insertion Block B2)

When the image data as the object in which the insert image is inserted is inputted to the information processing apparatus 30, the inputted image data is inputted to the insert image insertion point detection part 355. When the image data is inputted, the insert image insertion point detection part 355 detects a point such as a scene change at which the insert shot is to be inserted (hereinafter referred to as an insertion point) from the inputted image data. Information of the insertion point detected by the insert image insertion point detection part 355 is inputted to the inserted insert image decision part 356.

When the information of the insertion point is inputted, the inserted insert image decision part 356 decides the insert image suitable for insertion at the inputted insertion point (hereinafter referred to as an inserted insert image) out of the insert images stored in the insert image buffer 354. The inserted insert image decided by the inserted insert image decision part 356 is inputted to the insert image insertion part 357. When the inserted insert image is inputted, the insert image insertion part 357 inserts the inserted insert image, which is thus inputted, at the insertion point, and outputs the image data in which the inserted insert image is inserted (hereinafter referred to as an image data after insertion).

As above, the configuration of the information processing apparatus 30 has been roughly described. Hereafter, main constituents of the information processing apparatus 30 are described more in detail.

(Details of Insert Image Selection Part 351)

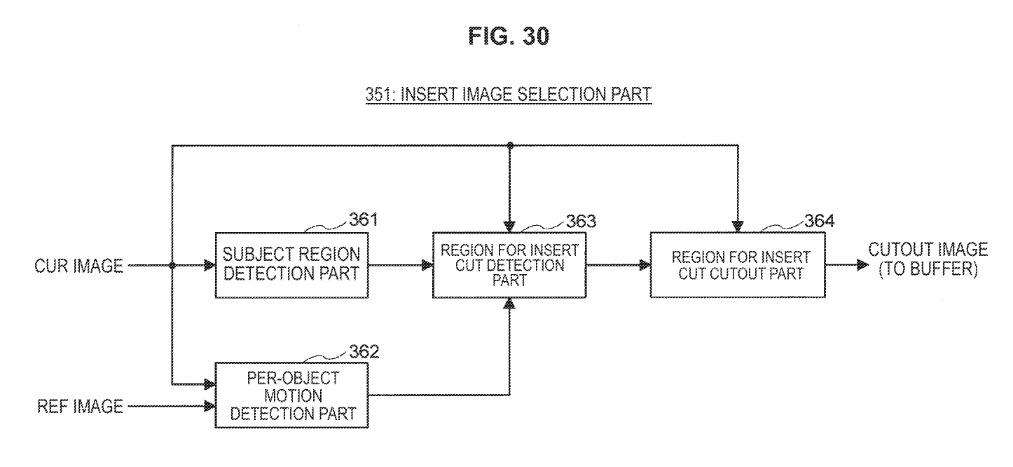

At first, a configuration of the insert image selection part 351 is described more in detail with reference to FIG. 30. FIG. 30 is an explanatory drawing for explaining the configuration of the insert image selection part 351 more in detail.

As illustrated in FIG. 30, the insert image selection part 351 mainly includes a subject region detection part 361, a per-object motion detection part 362, a region for insert cut detection part 363 and a region for insert cut cutout part 364. In addition, the function of the subject region detection part 361 is substantially same as the function of the above-mentioned subject region detection part 301. Moreover, the function of the per-object motion detection part 362 is substantially same as the function of the above-mentioned per-object motion detection part 302.

When the CUR image is inputted to the insert image selection part 351, the CUR image is inputted to the subject region detection part 361, per-object motion detection part 362, region for insert cut detection part 363 and region for insert cut cutout part 364. The subject region detection part 361 to which the CUR image is inputted detects the subject region included in the CUR image based on the subject detection techniques. Information of the subject region detected by the subject region detection part 361 (subject region information) is inputted to the region for insert cut detection part 363.

The REF image used in detecting the motion vector of each object included in the CUR image is inputted to the per-object motion detection part 362. The per-object motion detection part 362 detects the motion vector of each object based on the inputted CUR image and REF image. Information indicating the motion vector of each object detected by the per-object motion detection part 362 (ObjectMV information) is inputted to the region for insert cut detection part 363.

When the CUR image, subject region information and ObjectMV information are inputted, the region for insert cut detection part 363 detects, from the CUR image, a region to be cutout (cutout region) as material for the insert image used for the insert shot. Information of the cutout region detected by the region for insert cut detection part 363 is inputted to the region for insert cut cutout part 364. When the information of the cutout region is inputted, the region for insert cut cutout part 364 cuts out a part of the CUR image according to the inputted information of the cutout region, and stores the image thus cut out (cutout image) in the cutout image buffer 353.

(Details of Region for insert cut Detection Part 363)

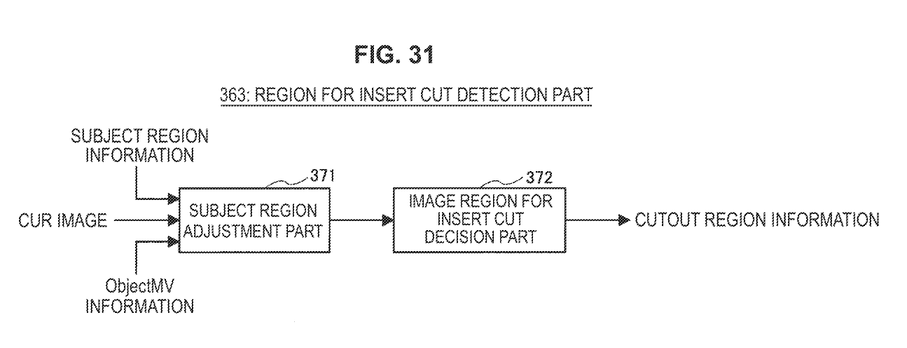

Herein, a configuration of the region for insert cut detection part 363 is described more in detail with reference to FIG. 31. FIG. 31 is an explanatory drawing for explaining the configuration of the region for insert cut detection part 363 more in detail.

As illustrated in FIG. 31, the region for insert cut detection part 363 mainly includes a subject region adjustment part 371 and an image region for insert cut decision part 372. In addition, the function of the subject region adjustment part 371 is substantially same as the function of the above-mentioned subject region adjustment part 331.

When the subject region information, CUR image and ObjectMV information are inputted to the region for insert cut detection part 363, these pieces of information are inputted to the subject region adjustment part 371. When these pieces of information are inputted, the subject region adjustment part 371 compares the subject region identified from the subject region information with the subject region identified from the ObjectMV information, and recognizes the subject region for which both of them are coincident with each other as a subject region after adjustment. In addition, the subject region adjustment part 371 may be configured so as to the subject region adjust using another method similarly to the above-mentioned subject region adjustment part 331.

Thus, information of the subject region after adjustment obtained by the subject region adjustment part 371 is inputted to the image region for insert cut decision part 372. When the information of the subject region is inputted, the image region for insert cut decision part 372 decides the cutout region used for the insert shot based on the inputted information of the subject region. For example, the image region for insert cut decision part 372 decides, as the cutout region, a rectangular region in the aspect ratio same as that of the moving image frame out of the region except the subject region.

As above, the configuration of the insert image selection part 351 has been described.

(Details of Insert Image Generation Part 352)

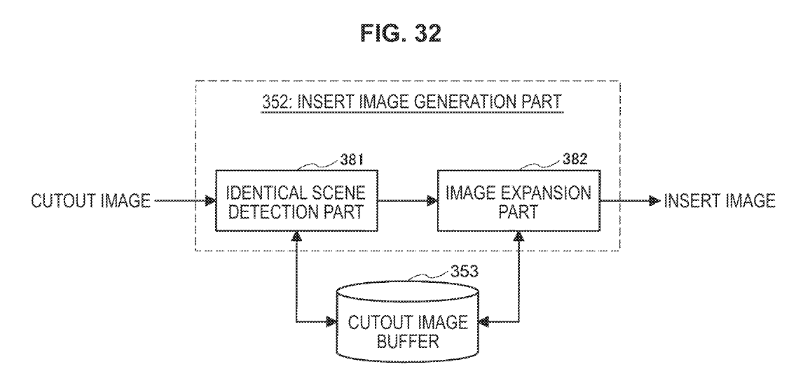

Next, a configuration of the insert image generation part 352 is described more in detail with reference to FIG. 32. FIG. 32 is an explanatory drawing for explaining the configuration of the insert image generation part 352 more in detail.

As illustrated in FIG. 32, the insert image generation part 352 mainly includes an identical scene detection part 381 and an image expansion part 382.

When the cutout image is inputted to the insert image generation part 352, the inputted cutout image is inputted to the identical scene detection part 381. The identical scene detection part 381 in which the cutout image is inputted detects the cutout image corresponding to the scene identical with that of the inputted cutout image out of the cutout images stored in the cutout image buffer 353. Then, the identical scene detection part 381 inputs information of the detected cutout image in the identical scene to the image expansion part 382.

In addition, since it is herein supposed that the cutout image is expanded, applying a super-resolution technique which uses a plurality of moving image frames, the block is provided which prepares the cutout images in the identical scene. However, in case of a super-resolution technique which uses one moving image frame, this block is not necessary. Moreover, also in case of expanding a cutout image using a technique such as bicubic interpolation and bilinear interpolation, not using the super-resolution techniques, the above-mentioned block is not necessary. The description, however, is herein made, supposing that the super-resolution technique using a plurality of moving image frames is applied.

In addition, in the above-mentioned technique of expanding the cutout image from one moving image frame, methods can be applied in which, in case of a plurality of identical scenes being present, one with good quality is selected and used out of the identical scenes, and the like. For example, selecting and using a moving image frame less in blur and/or unsharpness or a moving image frame less in noise out of the identical scenes enables suppressing deterioration of the cutout image in image quality.

When information of the cutout image in the identical scene is inputted, the image expansion part 382 performs super-resolution processing on the current cutout image using the current cutout image and the cutout image in the identical scene with that of the current cutout image, and expands the current cutout image up to the size same as that of the moving image frame. The cutout image expanded by the image expansion part 382 is outputted as the insert image.

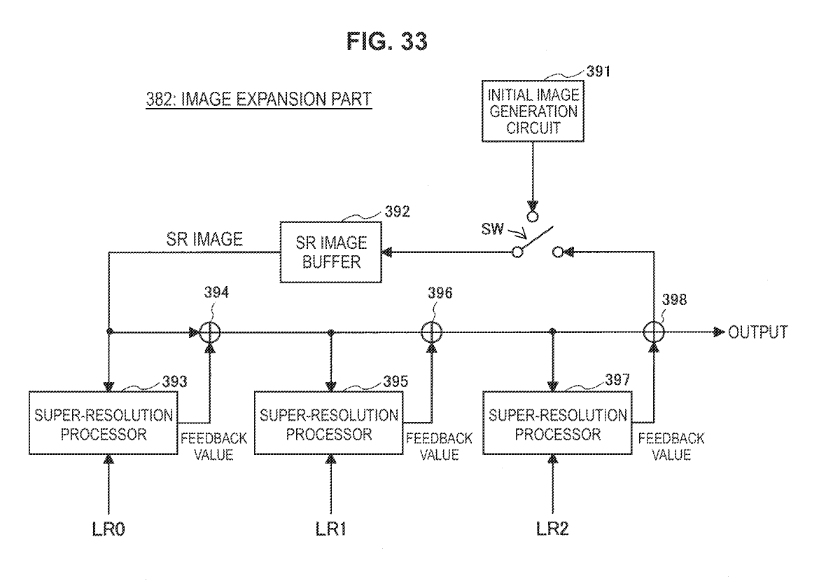

In addition, the image expansion part 382 can be configured as illustrated in FIG. 33, for example. In the example of FIG. 33, the image expansion part 382 mainly includes an initial image generation circuit 391, an SR image buffer 392, super-resolution processors 393, 395 and 397, adders 394, 396 and 398, and a switch SW. In addition, it is recommended to refer to Japanese Patent Laid-Open No. 2008-140012 for detailed configuration and operation of the image expansion part 382 exemplified in FIG. 33.

As above, the configuration of the insert image generation part 352 has been described.

(Details of Insert Image Insertion Point Detection Part 355)

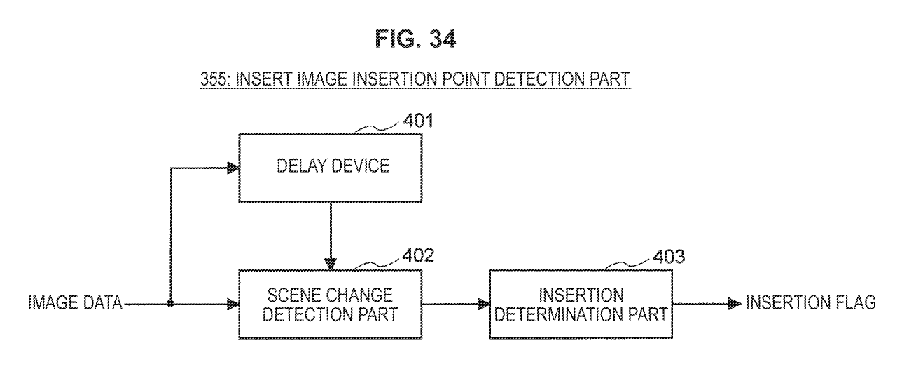

Next, a configuration of the insert image insertion point detection part 355 is described more in detail with reference to FIG. 34. FIG. 34 is an explanatory drawing for explaining the configuration of the insert image insertion point detection part 355 more in detail.

As illustrated in FIG. 34, the insert image insertion point detection part 355 mainly includes a delay device 401, a scene change detection part 402 and an insertion determination part 403.

When the image data is inputted to the insert image insertion point detection part 355, the inputted image data is inputted to the delay device 401 and scene change detection part 402. The delay device 401 delays output of the image data by one frame. Therefore, when the current image data is inputted, the delay device 401 inputs the image data before the current image data by one frame to the scene change detection part 402. Accordingly, the current image data and the previous image data by one frame are inputted to the scene change detection part 402.

When the current image data and the previous image data by one frame are inputted, the scene change detection part 402 detects scene change, comparing the inputted two image data. The detection result obtained by the scene change detection part 402 is notified to the insertion determination part 403. When any scene change is detected, the insertion determination part 403 determines “insertion positive,” and outputs an insertion flag indicating the insertion point. On the other hand, when no scene change is detected, the insertion determination part 403 determines “insertion negative,” and outputs an insertion flag not indicating any insertion point.

In addition, the method is herein introduced in which scene change is detected based on the target frame and the frame locating before or after the frame, whereas scene change can also be detected by referring to frames other than the frame locating before or after. For example, in case of unwantedly filming the toes by several frames, or the like, the insertion point is set for the corresponding plural frames. Thereby, the insert image is inserted in the relevant portion.

As above, the configuration of the insert image insertion point detection part 355 has been described.

As above, the functional configuration of the information processing apparatus 30 has been described in detail.

[3-2: Operation of Information Processing Apparatus 30 (FIG. 35 to FIG. 40)]

Next, operation of the information processing apparatus 30 is described with reference to FIG. 35 to FIG. 40. FIG. 35 to FIG. 40 are explanatory drawings for explaining the operation of the information processing apparatus 30.

(Overall Flow of Processing in Insert Image Generation Block B1)

At first, an overall flow of processing in the insert image generation block B1 is described with reference to FIG. 35. FIG. 35 is an explanatory drawing for explaining the overall flow of processing in the insert image generation block B1.

As illustrated in FIG. 35, the insert image generation block B1 at first selects an image suitable for the insert image, and stores it in the cutout image buffer (S401). Next, the insert image generation block B1 expands the image selected in step S401 up to the frame size to generate the insert image (S402). Next, the insert image generation block B1 stores the insert image generated in step S402 in the insert image buffer (S403), and ends the series of processes according to the generation of the insert image.

As above, the overall flow of the processing in the insert image generation block B1 has been described.

(Flow of Processing According to Selection of Insertion-Contributed Image)

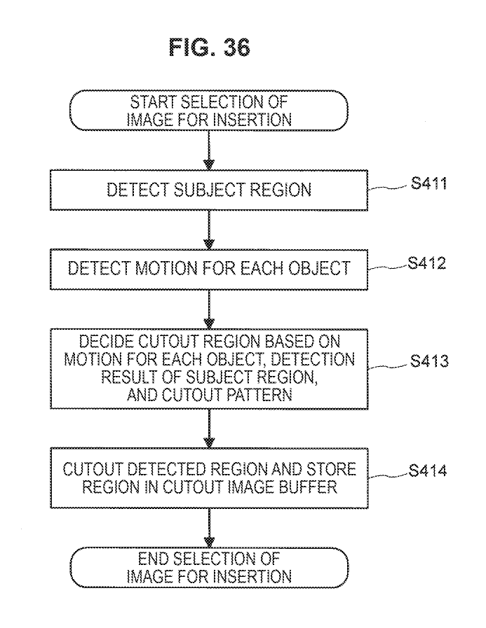

Next, a flow of processing according to selection of an insertion-contributed image is described more in detail with reference to FIG. 36. FIG. 36 is an explanatory drawing for explaining the flow of processing according to selection of an insertion-contributed image.

As illustrated in FIG. 36, the insert image generation block B1 at first detects the subject region (S411). Next, the insert image generation block B1 detects the motion vector for each object (S412). Next, the insert image generation block B1 decides the cutout region for cutting out material for the insert image based on the motion vector for each object, detection result of the subject region, and cutout pattern (S413). Next, the insert image generation block B1 cuts out the cutout region detected in step S413, stores the cutout image in the cutout image buffer (S414), and ends the series of processes according to the selection of the insertion-contributed image. In addition, the processes in step S411 and S412 may be reversed in their order.

As above, the flow of the processing according to the selection of the insertion-contributed image has been described.

(Flow of Processing According to Detection of Insert Image-Contributed Region)

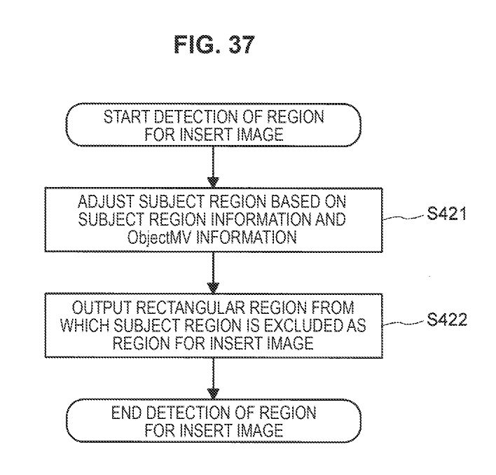

Next, a flow of processing according to detection of an insert image-contributed region is described with reference to FIG. 37. FIG. 37 is an explanatory drawing for explaining the flow of processing according to detection of an insert image-contributed region.

As illustrated in FIG. 37, the insert image generation block B1 adjusts the subject region based on the subject region information and ObjectMV information (S421). Next, the insert image generation block B1 outputs a rectangular region from which the subject region is excluded as an insert image-contributed region (cutout region) (S422), and ends the series of processes according to the detection of the insert image-contributed region.

As above, the flow of the processing according to the detection of the insert image-contributed region has been described.

(Flow of Processing According to Generation of Insert Image)

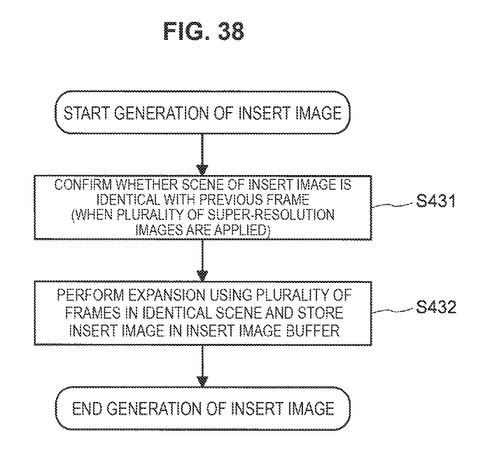

Next, a flow of processing according to generation of an insert image is described with reference to FIG. 38. FIG. 38 is an explanatory drawing for explaining the flow of processing according to generation of an insert image.

As illustrated in FIG. 38, the insert image generation block B1 confirms whether or not the image data has the same scene as that of the previous frame (S431). In addition, in case of not using super-resolution applied to a plurality of cutout images in expanding those, step S431 can be omitted. Next, the insert image generation block B1 expands, while applying super-resolution using a plurality of frames in the same scene, the current frame (cutout image), stores it in the insert image buffer (S432), and ends the series of processes according to the generation of the insert image.

In addition, the insert image generation block B1 may be configured to perform the cutout processing in consideration of a sequence corresponding to motion in a predetermined time and generate the insert image from the cutout image (in this case, the insert images are obtained as a moving image) to store it in the buffer. According to such a configuration, insert images can be utilized which are obtained by capturing an image of motion of flags, motion of attendance or the like for a predetermined time in the scene of a sports meeting, for example. Namely, a moving image suitable for insertion can be inserted. Moreover, in consideration of usage as a moving image, it is preferable to perform processing such as removing blur in image capturing and/or to improve expansion processing or the like so as not to be awkward as a moving image.

As above, the flow of the processing according to the generation of the insert image has been described.

(Overall Flow of Processing in Insert Image Insertion Block B2)

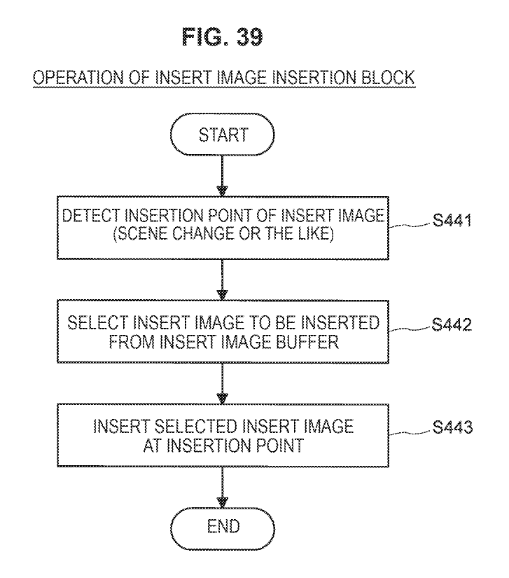

Next, an overall flow of processing in the insert image insertion block B2 is described with reference to FIG. 39. FIG. 39 is an explanatory drawing for explaining the overall flow of processing in the insert image insertion block B2.

As illustrated in FIG. 39, the insert image insertion block B2 at first detects the insertion point of the insert image (S441), For example, the insert image insertion block B2 detects a point at which scene change arises as the insertion point. Next, the insert image insertion block B2 selects the inserted insert image from the insert image buffer (S442). Next, the insert image insertion block B2 the insert image selected in step S442 at the insertion point (S443), and ends the series of processes.

As above, the overall flow of the processing in the insert image insertion block B2 has been described.

(Flow of Processing According to Detection of Insertion Point)

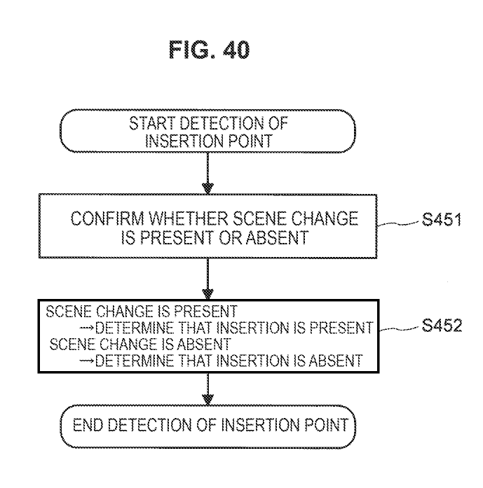

Next, a flow of processing according to detection of an insertion point is described with reference to FIG. 40. FIG. 40 is an explanatory drawing for explaining the flow of processing according to detection of an insertion point.

As illustrated in FIG. 40, the insert image insertion block B2 at first confirms whether scene change is present or absent (S451). Next, the insert image insertion block B2 outputs an insertion flag indicating that “insertion is present” when scene change is present, outputs an insertion flag indicating that “insertion is absent” when scene change is absent (S452), and ends the series of processes according to the detection of the insertion point.

As above, the flow of the processing according to the detection of the insertion point has been described. In addition, in the above-mentioned description, the processing of inserting one insert image is targeted and described, whereas it can be extended to a configuration in which a moving image constituted of a plurality of moving image frames is inserted. Moreover, in case of preparing an insert image for a predetermined time (for example, 5 seconds), insert images can be generated from moving image frames corresponding to the time. Moreover, the same moving image frames can be inserted for a predetermined time.

As above, the operation of the information processing apparatus 30 has been described.

[3-3: Application Example #1 (Decision Method of Insertion Position Considering Voice)]

In the above-mentioned description, the method is introduced in which the scene change is detected by comparing the image of the previous frame with the image of the current frame, whereas the detection method of the scene change is not limited to the above-mentioned method in applying the technique according to the embodiment. For example, methods can be considered in which the scene change is detected using voice, and the like. For example, in the case that background voice in music of a sports meeting, or the like is continuous, it can be determined that no scene change arises. More specifically, a method is expected to be effective in which it is determined that no scene change arises when background voice is continuous even in case that it is determined that there is a scene change based on the comparison of images. Thus, applying voice to the scene change enables detection of the scene change in improved accuracy and more preferred detection of the insertion point.

[3-4: Application Example #2 (Selection Method of Insert Image Considering Tone of Color)]

Moreover, as to the selection method of the insert image, more natural insert shots can be realized, for example, by selecting an insert image from a moving image frame as close to the insertion point as possible, or by selecting an insert image with close tone of color. For example, a method can be considered in which (average value of all pixel values in prior frame+average value of all pixel values in posterior frame)/2 is compared with an average value of all the pixel values for an insert image candidate and the candidate having the least difference between both of them is employed as the insert image. Moreover, it is practically expected to be effective to restrict the insert image having been used for the insertion not to be used again, or the like. Moreover, a method can be considered in which an insert image is selected and inserted which image is beforehand prepared regardless of the moving image in case of no suitable insert image after such considerations.

As above, the details of the insert shot image insertion technique according to the embodiment have been described.

### 4: EXAMPLE HARDWARE CONFIGURATION (FIG. 41)

Functions of each constituent included in the information processing apparatuses 30 and the information processing system 20 described above can be realized by using, for example, the hardware configuration shown in FIG. 41. That is, the functions of each constituent can be realized by controlling the hardware shown in FIG. 41 using a computer program. Additionally, the mode of this hardware is arbitrary, and may be a personal computer, a mobile information terminal such as a mobile phone, a PHS or a PDA, a game machine, or various types of information appliances. Moreover, the PHS is an abbreviation for Personal Handy-phone System. Also, the PDA is an abbreviation for Personal Digital Assistant.

As shown in FIG. 41, this hardware mainly includes a CPU 902, a ROM 904, a RAM 906, a host bus 908, and a bridge 910. Furthermore, this hardware includes an external bus 912, an interface 914, an input unit 916, an output unit 918, a storage unit 920, a drive 922, a connection port 924, and a communication unit 926. Moreover, the CPU is an abbreviation for Central Processing Unit. Also, the ROM is an abbreviation for Read Only Memory. Furthermore, the RAM is an abbreviation for Random Access Memory.

The CPU 902 functions as an arithmetic processing unit or a control unit, for example, and controls entire operation or a part of the operation of each structural element based on various programs recorded on the ROM 904, the RAM 906, the storage unit 920, or a removal recording medium 928. The ROM 904 is a medium for storing, for example, a program to be loaded on the CPU 902 or data or the like used in an arithmetic operation. The RAM 906 temporarily or perpetually stores, for example, a program to be loaded on the CPU 902 or various parameters or the like arbitrarily changed in execution of the program.

These structural elements are connected to each other by, for example, the host bus 908 capable of performing high-speed data transmission. For its part, the host bus 908 is connected through the bridge 910 to the external bus 912 whose data transmission speed is relatively low, for example. Furthermore, the input unit 916 is, for example, a mouse, a keyboard, a touch panel, a button, a switch, or a lever. Also, the input unit 916 may be a remote control that can transmit a control signal by using an infrared ray or other radio waves.

The output unit 918 is, for example, a display device such as a CRT, an LCD, a PDP or an ELD, an audio output device such as a speaker or headphones, a printer, a mobile phone, or a facsimile, that can visually or auditorily notify a user of acquired information. Moreover, the CRT is an abbreviation for Cathode Ray Tube. The LCD is an abbreviation for Liquid Crystal Display. The PDP is an abbreviation for Plasma Display Panel. Also, the ELD is an abbreviation for Electro-Luminescence Display.

The storage unit 920 is a device for storing various data. The storage unit 920 is, for example, a magnetic storage device such as a hard disk drive (HDD), a semiconductor storage device, an optical storage device, or a magneto-optical storage device. The HDD is an abbreviation for Hard Disk Drive.

The drive 922 is a device that reads information recorded on the removal recording medium 928 such as a magnetic disk, an optical disk, a magneto-optical disk, or a semiconductor memory, or writes information in the removal recording medium 928. The removal recording medium 928 is, for example, a DVD medium, a Blu-ray medium, an HD-DVD medium, various types of semiconductor storage media, or the like. Of course, the removal recording medium 928 may be, for example, an electronic device or an IC card on which a non-contact IC chip is mounted. The IC is an abbreviation for Integrated Circuit.

The connection port 924 is a port such as an USB port, an IEEE1394 port, a SCSI, an RS-232C port, or a port for connecting an externally connected device 930 such as an optical audio terminal. The externally connected device 930 is, for example, a printer, a mobile music player, a digital camera, a digital video camera, or an IC recorder. Moreover, the USB is an abbreviation for Universal Serial Bus. Also, the SCSI is an abbreviation for Small Computer System Interface.

The communication unit 926 is a communication device to be connected to a network 932, and is, for example, a communication card for a wired or wireless LAN, Bluetooth (registered trademark), or WUSB, an optical communication router, an ADSL router, or a modem for various communication. The network 932 connected to the communication unit 926 is configured from a wire-connected or wirelessly connected network, and is the Internet, a home-use LAN, infrared communication, visible light communication, broadcasting, or satellite communication, for example. Moreover, the LAN is an abbreviation for Local Area Network. Also, the WUSB is an abbreviation for Wireless USB. Furthermore, the ADSL is an abbreviation for Asymmetric Digital Subscriber Line.

### 5: CONCLUSION

Last, the technical spirit of the embodiments is summarized simply. The technical spirit described below can be applied to various information processing apparatuses such as PCs, mobile phones, handheld game consoles, mobile information terminals, information home appliances and car navigation systems.

The functional configuration of the above-mentioned information processing apparatus can be presented as follows. For example, the information processing apparatus as presented in (1) below decides the cutout region utilizing the motion information for each object, and therefore, enables to adjust, while leaving a thing toward which the object is going to move, composition of the moving image frame as composition excellent in balance.

It should be understood by those skilled in the art that various modifications, combinations, sub-combinations and alterations may occur depending on design requirements and other factors insofar as they are within the scope of the appended claims or the equivalents thereof.

(1) An information processing apparatus including:

a motion detection part detecting motion information of an object included in a moving image frame; and

a cutout region decision part deciding a region to be cutout from the moving image frame using the motion information detected for each object by the motion detection part.

(2) The information processing apparatus according to (1), further including:

an object detection part detecting the object included in the moving image frame,

wherein the cutout region decision part decides a region to be cutout from the moving image frame based on the motion information detected for each object by the motion detection part and a detection result of the object detected by the object detection part.

(3) The information processing apparatus according to (2),

wherein the cutout region decision part extracts an object region corresponding to a substantial outer shape of the object using the motion information detected for each object and the detection result of the object, and decides a region to be cutout from the moving image frame based on an arrangement of the extracted object region and a predetermined cutout pattern on the basis of the arrangement of the object region.

(4) The information processing apparatus according to any one of (1) to (3),

wherein, in a case where a plurality of objects are included in the moving image frame, the motion detection part detects the motion information of each of the plurality of objects.

(5) The information processing apparatus according to any one of (1) to (4),

wherein the motion detection part outputs motion information included in codec information of the moving image frame as a detection result.

(6) The information processing apparatus according to (3), further including:

an object identification part identifying whether the object detected by the object detection part is a subject or a background,

wherein the cutout region decision part decides a region to be cutout from the moving image frame based on an arrangement of an object region of the object identified as the subject and an object region of the object identified as the background, and the predetermined cutout pattern.

(7) The information processing apparatus according to (3), further including:

an object identification part identifying whether the object detected by the object detection part is a subject or a background,

wherein the cutout region decision part decides a region to be cutout from the moving image frame based on an arrangement of an object region of the object identified as the subject and the predetermined cutout pattern.

(8) The information processing apparatus according to any one of (1) to (5),

wherein the cutout region decision part decides a region to be cutout as a material usable for an insert cut from a region within the moving image frame that excludes an object region of an object identified as a subject, and

wherein the information processing apparatus further includes:

an insert image generation part generating, by cutting out the region decided by the cutout region decision part from the moving image frame and using an image of the region, an insert image to be inserted into a moving image as the insert cut.

(9) The information processing apparatus according to (8), further including:

an insertion position detection part detecting a position at which the insert image is to be inserted; and

an insert image insertion part inserting the insert image generated by the insert image generation part at the position detected by the insertion position detection part.

(10) The information processing apparatus according to (9),

wherein the cutout region decision part decides a plurality of regions to be cutout,

wherein the insert image generation part generates a plurality of insert images corresponding to the plurality of regions to be cutout, and

wherein the insert image insertion part inserts an insert image selected from the plurality of insert images at the position detected by the insertion position detection part.

(11) A terminal apparatus including:

an image acquisition part acquiring a cutout image obtained via processes of detecting motion information of an object included in a moving image frame, deciding a region to be cutout from the moving image frame using the motion information detected for each object, and cutting out the decided region from the moving image frame.

(12) The terminal apparatus according to (11), further including:

a moving image playback part playing back a moving image in which a moving image frame corresponding to the cutout image is replaced with the cutout image or an image obtained by processing the cutout image.

(13) The terminal apparatus according to (11) or (12),

wherein the process of deciding the region to be cutout is a process of deciding a region to be cutout from the moving image frame based on the motion information detected for each object and a detection result of the object with object detection.

(14) The terminal apparatus according to (13),

wherein the process of deciding the region to be cutout is a process of, by extracting an object region corresponding to a substantial outer shape of the object using the motion information detected for each object and the detection result of the object, deciding a region to be cutout from the moving image frame based on an arrangement of the extracted object region and a predetermined cutout pattern on the basis of an arrangement of the object region.

(15) The terminal apparatus according to any one of (11) to (14),

wherein, in a case where a plurality of objects are included in the moving image frame, the process of detecting the motion information is a process of detecting motion information of each of the plurality of objects.

(16) The terminal apparatus according to any one of (11) to (15),

wherein the process of detecting the motion information is a process of outputting motion information included in codec information of the moving image frame as a detection result.

(17) The terminal apparatus according to (11),

wherein the process of deciding the region to be cutout is a process of deciding a region to be cutout as a material usable for an insert cut from a region within the moving image frame that excludes an object region of an object identified as a subject,

wherein the image acquisition part acquires an insert image that is generated using the cutout image and is inserted in a moving image as the insert cut, and

wherein the terminal apparatus further includes:

a moving image playback part playing back the moving image into which the insert image is inserted.

(18) An image capturing apparatus including:

a moving image provision part providing a captured moving image to a predetermined appliance;

an auxiliary information acquisition part acquiring auxiliary information from the predetermined appliance that has performed processes of detecting motion information of an object included in a moving image frame of the captured moving image, deciding a region to be cutout from the moving image frame using the motion information detected for each object, and generating the auxiliary information regarding an image capturing method for capturing an image of the decided region; and

an information provision part providing the auxiliary information to a user.

(19) An information processing method including:

detecting motion information of an object included in a moving image frame; and

deciding a region to be cutout from the moving image frame using the motion information detected for each object.

(20) An information provision method for an image capturing apparatus, including:

providing a captured moving image to a predetermined appliance;

acquiring auxiliary information from the predetermined appliance that has performed processes of detecting motion information of an object included in a moving image frame of the captured moving image, deciding a region to be cutout from the moving image frame using the motion information detected for each object, and generating the auxiliary information regarding an image capturing method for capturing an image of the decided region; and

providing the auxiliary information to a user.

(21) A program capable of causing a computer to realize functions of individual elements included in the information processing apparatus, the terminal apparatus or the image capturing apparatus according to any one of (1) to (18) described above. A computer-readable recording medium having the program recorded thereon.

(Remark)

The above-mentioned per-object motion detection part 302 is one example of the motion detection part. The above-mentioned subject region detection part 301 is one example of the object detection part and object identification part. The above-mentioned insert image insertion point detection part 355 is one example of the insertion position detection part. The above-mentioned image data transmission part 102 is one example of the moving image provision part. The above-mentioned advice reception part 104 is one example of the auxiliary information acquisition part. The above-mentioned advice provision part 105 is one example of the information provision part.

It should be understood by those skilled in the art that various modifications, combinations, sub-combinations and alterations may occur depending on design requirements and other factors insofar as they are within the scope of the appended claims or the equivalents thereof.

The present disclosure contains subject matter related to that disclosed in Japanese Priority Patent Application JP 2012-037352 filed in the Japan Patent Office on Feb. 23, 2012, the entire content of which is hereby incorporated by reference.

What is claimed is:

1. An information processing apparatus comprising:
a motion detection part detecting motion information of an object included in a moving image frame; and
a cutout region decision part deciding a region to be cutout from the moving image frame using the motion information detected for each object by the motion detection part.

2. The information processing apparatus according to claim 1, further comprising:
an object detection part detecting the object included in the moving image frame,
wherein the cutout region decision part decides a region to be cutout from the moving image frame based on the motion information detected for each object by the motion detection part and a detection result of the object detected by the object detection part.

3. The information processing apparatus according to claim 2,
wherein the cutout region decision part extracts an object region corresponding to a substantial outer shape of the object using the motion information detected for each object and the detection result of the object, and decides a region to be cutout from the moving image frame based on an arrangement of the extracted object region and a predetermined cutout pattern on the basis of the arrangement of the object region.

4. The information processing apparatus according to claim 1,
wherein, in a case where a plurality of objects are included in the moving image frame, the motion detection part detects the motion information of each of the plurality of objects.

5. The information processing apparatus according to claim 1,
wherein the motion detection part outputs motion information included in codec information of the moving image frame as a detection result.

6. The information processing apparatus according to claim 3, further comprising:
an object identification part identifying whether the object detected by the object detection part is a subject or a background,
wherein the cutout region decision part decides a region to be cutout from the moving image frame based on an arrangement of an object region of the object identified as the subject and an object region of the object identified as the background, and the predetermined cutout pattern.

7. The information processing apparatus according to claim 3, further comprising:
an object identification part identifying whether the object detected by the object detection part is a subject or a background,
wherein the cutout region decision part decides a region to be cutout from the moving image frame based on an arrangement of an object region of the object identified as the subject and the predetermined cutout pattern.

8. The information processing apparatus according to claim 1,
wherein the cutout region decision part decides a region to be cutout as a material usable for an insert cut from a region within the moving image frame that excludes an object region of an object identified as a subject, and
wherein the information processing apparatus further comprises:
an insert image generation part generating, by cutting out the region decided by the cutout region decision part from the moving image frame and using an image of the region, an insert image to be inserted into a moving image as the insert cut.

9. The information processing apparatus according to claim 8, further comprising:
an insertion position detection part detecting a position at which the insert image is to be inserted; and
an insert image insertion part inserting the insert image generated by the insert image generation part at the position detected by the insertion position detection part.

10. The information processing apparatus according to claim 9,
wherein the cutout region decision part decides a plurality of regions to be cutout,
wherein the insert image generation part generates a plurality of insert images corresponding to the plurality of regions to be cutout, and
wherein the insert image insertion part inserts an insert image selected from the plurality of insert images at the position detected by the insertion position detection part.

11. A terminal apparatus comprising:
an image acquisition part acquiring a cutout image obtained via processes of detecting motion information of an object included in a moving image frame, deciding a region to be cutout from the moving image frame using the motion information detected for each object, and cutting out the decided region from the moving image frame.

12. The terminal apparatus according to claim 11, further comprising:
a moving image playback part playing back a moving image in which a moving image frame corresponding to the cutout image is replaced with the cutout image or an image obtained by processing the cutout image.

13. The terminal apparatus according to claim 11,
wherein the process of deciding the region to be cutout is a process of deciding a region to be cutout from the moving image frame based on the motion information detected for each object and a detection result of the object with object detection.

14. The terminal apparatus according to claim 13,
wherein the process of deciding the region to be cutout is a process of, by extracting an object region corresponding to a substantial outer shape of the object using the motion information detected for each object and the detection result of the object, deciding a region to be cutout from the moving image frame based on an arrangement of the extracted object region and a predetermined cutout pattern on the basis of an arrangement of the object region.

15. The terminal apparatus according to claim 11,
wherein, in a case where a plurality of objects are included in the moving image frame, the process of detecting the motion information is a process of detecting motion information of each of the plurality of objects.

16. The terminal apparatus according to claim 11,
wherein the process of detecting the motion information is a process of outputting motion information included in codec information of the moving image frame as a detection result.

17. The terminal apparatus according to claim 11,
wherein the process of deciding the region to be cutout is a process of deciding a region to be cutout as a material usable for an insert cut from a region within the moving image frame that excludes an object region of an object identified as a subject,
wherein the image acquisition part acquires an insert image that is generated using the cutout image and is inserted in a moving image as the insert cut, and
wherein the terminal apparatus further comprises:
a moving image playback part playing back the moving image into which the insert image is inserted.

18. An image capturing apparatus comprising:
a moving image provision part providing a captured moving image to a predetermined appliance;
an auxiliary information acquisition part acquiring auxiliary information from the predetermined appliance that has performed processes of detecting motion information of an object included in a moving image frame of the captured moving image, deciding a region to be cutout from the moving image frame using the motion information detected for each object, and generating the auxiliary information regarding an image capturing method for capturing an image of the decided region; and
an information provision part providing the auxiliary information to a user.

19. An information processing method comprising:
detecting motion information of an object included in a moving image frame; and
deciding a region to be cutout from the moving image frame using the motion information detected for each object.

20. An information provision method for an image capturing apparatus, comprising:
providing a captured moving image to a predetermined appliance;
acquiring auxiliary information from the predetermined appliance that has performed processes of detecting motion information of an object included in a moving image frame of the captured moving image, deciding a region to be cutout from the moving image frame using the motion information detected for each object, and generating the auxiliary information regarding an image capturing method for capturing an image of the decided region; and
providing the auxiliary information to a user.
